(19) United States
(12) Patent Application Publication
(10) Pub. No.: US 2017/0092033 A1
(43) Pub. Date: Mar. 30, 2017

(54) APPARATUS AND METHOD

(71) Applicant: INNOVIA FILMS LIMITED, Wigton, Cumbria (GB)

(72) Inventor: Robert STEWART, Wigton, Cumbria (GB)

(21) Appl. No.: 15/126,915

(22) PCT Filed: Mar. 26, 2015
(86) PCT No.: PCT/GB2015/050918

§ 371 Date: Sep. 16, 2016

(30) Foreign Application Priority Data
Apr. 8, 2014 (GB) 1406332.5

(51) Int. Cl. G07D 7/12

(52) U.S. Cl. CPC G07D 7/122; G07D 7/121

(57) ABSTRACT

The present invention provides apparatus for indicating if a security document comprises one or more specified characteristics. The invention also provides a method of indicating if a security document comprises one or more specified characteristics, and a banknote counting apparatus comprising the apparatus.

This application is a national stage application of International Patent Application No. PCT/GB2015/050918, filed Mar. 26, 2015, which claims priority to United Kingdom patent Application No. 1406332.5, filed Apr. 8, 2014. The entirety of the aforementioned applications is incorporated herein by reference.

### FIELD

The present invention relates to an apparatus for and method of indicating if a security document comprises one or more specified characteristics, and particularly, but not exclusively, to an apparatus for and method of indicating whether a multilayer polymer film substrate forming part of the security document is genuine or counterfeit depending upon those specified characteristics being present or absent.

### BACKGROUND

The use of polymer films as substrates in fields where security, authentication, identification and anti-counterfeiting are important is becoming increasingly common. Polymer-based security documents in such areas include for example bank notes, important documents (e.g. ID materials such as for example passports and land title, share and educational certificates), films for packaging high-value goods for anti-counterfeiting purposes, and security cards.

Polymer-based secure materials have advantages in terms of security, functionality, durability, cost-effectiveness, cleanliness, processability and environmental considerations. Perhaps the most notable amongst these is the security advantage. Paper-based bank notes, for example, can be relatively easy to copy, and there is lower occurrence of counterfeits in countries with polymer-based bank notes compared to paper-based bank notes. Polymer-based bank notes are also longer-lasting and less-easily torn.

Security materials based on polymer films are amenable to the incorporation of a variety of visible and hidden security features. Since the introduction of the first polymer bank notes approximately 30 years ago, security features have included optically variable devices (OVD), opacification features, printed security features, security threads, embossings, transparent windows and diffraction gratings. Aside from complicated security features there is also the more immediate advantage that the high temperatures used in copying machines will often cause melting or distortion of polymer base-material if counterfeiters attempt simply to copy secure materials (e.g. bank notes) using such machines.

A variety of polymers may be used as secure substrates. Amongst these is polypropylene film. The three main methods of manufacturing polypropylene film are the stenter method, the cast method and the bubble method.

In the cast and stenter methods, polymer chips are typically placed in an extruder and heated so that an extrudate is forced out of a slit die onto a chilled roller to form a film (in the case of the cast method) or a thick polymer ribbon (in the case of the stenter method). In the stenter method, the thick polymer ribbon is then reheated and then stretched lengthways (termed the “machine direction”) and widthways (termed the “transverse direction”) to form a film. In general, the stretching in the machine and transverse directions occurs sequentially and is generally non-homogenous, i.e. there is a greater degree of stretching in the transverse direction compared with the machine direction.

In the bubble method, the polymer is extruded not through a slit die but through an annular die, to form a relatively thick extrudate, in the form of a hollow cylinder or “drainpipe” shape through which air is blown. The annular die is at the top of an apparatus which is typically the equivalent of several storeys high (for example 40 to 50 metres). The extrudate moves downwards and is heated sequentially so that it is expanded to form a bubble. The bubble is then slit into two half-bubbles, each of which may be used individually as “monoweb” films; or alternatively the two halves may be nipped and laminated together to form a double thickness film (or the bubble may be collapsed to form a double thickness film). Typically there are three concentric annuli at the die, so that the hollow cylinder is an extrudate of three layers. For example, there may be a core layer of polypropylene with a terpolymer skin layer on one side and another terpolymer skin layer on the other side. In this case the monoweb would consist of three layers with polypropylene in the middle and the double web would consist of five layers because the layer in the middle would be the same skin layer (terpolymer) of each half-bubble. Many other possible arrangements and components are possible, for example in terms of the number of annuli, type of skin layer, type of core layer, etc.

Thus the bubble method results in a thin film (for example 10 to 100 microns thick) by forming a bubble whereas the stenter method results in a thin film by stretching the material on a flat frame. In the bubble method, stretching occurs simultaneously in both the machine and transverse directions, and the degree of stretching in both directions is generally the same. Thus, the bubble method results in homogeneously stretched film which is different to and for some purposes advantageous over stenter film. Biaxially Oriented Polypropylene (BOPP) film is made by the bubble process by Innovia Films Ltd., Wigton, UK. In addition to polypropylene, other polymers (e.g. LLDPE, polypropylene/butylene copolymers) may also be formed as thin films using the bubble process.

It is known to introduce features to a film used as a substrate for security documents, identity documents or value documents and articles which are not readily apparent to a potential unauthorised user or counterfeiter. Even if those features are identified, in general, they cannot be readily reproduced. The introduction of such security features may also be applicable to other tokens or articles requiring verification of authentication, such as entrance documents and tickets.

Previous authentication apparatus and methods make use of known sheets of security document substrate which are permeable to electro-magnetic radiation, for example, transparent in the visible region of the electro-magnetic spectrum. It is known to create security documents, such as banknotes, by printing opaque inks onto sheets of transparent plastics substrate material, leaving a transparent window. The resulting window provides an overt security feature which is conspicuous to the human eye. It is known to print, etch or embed additional optical security features, such as optically variable devices formed by diffraction gratings, onto or into the resulting transparent windows, to provide additional overt security features. It is known to provide automatic authentication apparatus which can determine authenticity from the presence or absence of these additional optical security features, but such apparatus is typically complex and expensive.

Film manufacturers may provide covert security features in a film as an alternative, or in addition, to overt security features.

In some instances, covert security features may be more desirable than their overt counterparts because they do not change the basic appearance of the film.

A covert security feature may comprise, for example, an invisible chemical or physical marker which is added to one or more layers of the film substrate. These types of additives are commonly known as taggants.

Taggants can be used as an invisible chemical or physical marker for authentication of products and documents. Indeed, taggants are being increasingly used by brand owners and/or governments to authenticate commonly counterfeited items. Taggants can be integrated into the material of the item itself or into the packaging. In the field of polymer film substrates, the taggants could be placed inside of or formed as part of a film substrate. For example, a taggant could be integrated into the material forming a layer of a multilayer film substrate, and the taggant-containing layer could serve as an “active” or “reference” layer.

An authentication process for verifying if a film substrate is genuine or non-genuine (i.e. counterfeit) may employ an authentication apparatus arranged to detect for the presence of a taggant in the film substrate. If presence of a taggant is determined, the apparatus is arranged to provide an indication that the film is genuine.

However, it may be possible to deceive authentication apparatus of this type. Such apparatus operate to detect for the presence or otherwise of the taggant but may not operate to detect a location of the taggant. Thus, the apparatus may be unable to determine if a detected taggant-containing layer is located in a surface coating or within at least one layer in the body of the film substrate.

Therefore, should a counterfeiter become aware of the nature of the taggant used in an internal active or reference layer of a film forming part of a security document, that counterfeiter may be able to produce counterfeit films (and consequently counterfeit security documents). This may be done by forming a coating on a film substrate, with the coating containing the taggant. To an authentication apparatus arranged to detect for the presence of such a taggant, the counterfeit film substrate with the taggant in the surface coating may be indistinguishable from a genuine film substrate where the taggant is part of an internal layer. Thus, the authentication apparatus may give a false positive verification decision (i.e. that a counterfeit film is genuine even though it is, in fact, counterfeit) because it has been deceived by the taggant-containing surface coating of the counterfeit film substrate.

A counterfeiter may face great difficulty in first identifying a taggant material incorporated into the film substrate of a security document and, secondly, producing a film substrate for a security document in which the taggant material is contained within a surface coating. However, both issues are not insurmountable problems for a determined counterfeiter.

### BRIEF DESCRIPTION OF THE DRAWINGS

FIG. 1 schematically illustrates an apparatus according to one or more embodiments of the invention;

FIG. 2 schematically illustrates a particular arrangement and mode of operation of the apparatus according to one or more embodiments of the present invention;

FIGS. 3a and 3b schematically illustrate graphs of measured intensity of reflections versus wavelength for electro-magnetic radiation reflected from different multilayer polymer film substrates;

FIG. 4 schematically illustrates a sequence of data processing steps forming part of a transformation function algorithm implemented by a processor of the apparatus in one or more embodiments of the invention to transform the data illustrated in FIG. 3a or 3b to a first data profile;

FIG. 5 illustrates the first data profile of a multilayer polymer film substrate tested using the apparatus 100 and obtained from the data of FIG. 3b by employing the transformation function schematically illustrated in FIG. 4;

FIG. 6a illustrates a modified specified data profile which is obtained by applying a mask function to an original specified data profile;

FIG. 6b illustrates a modified first data profile for a non-genuine multilayer polymer film where the modified first data profile is obtained by applying the mask function to the first data profile illustrated in FIG. 5;

FIG. 6c illustrates a modified first data profile for a genuine multilayer polymer film where the modified first data profile is obtained by applying the mask function to the first data profile for that genuine multilayer polymer film;

FIG. 7 schematically illustrates another particular arrangement and mode of operation of the apparatus according to one or more embodiments of the present invention;

FIG. 8 schematically illustrates yet another particular arrangement and mode of operation of the apparatus according to one or more embodiments of the present invention;

FIG. 9 schematically illustrates a further particular arrangement and mode of operation of the apparatus according to one or more embodiments of the present invention;

FIG. 10 schematically illustrates a graph of measured intensity versus focal point position for electro-magnetic radiation received from a multilayer polymer film substrate as tested using the particular arrangement of the apparatus illustrated in FIG. 9;

FIG. 11 schematically illustrates a yet further particular arrangement and mode of operation of the apparatus according to one or more embodiments of the present invention;

FIG. 12a schematically illustrates a graph of measured intensity versus wavelength for electro-magnetic radiation received from a multilayer polymer film substrate as tested using the particular arrangement of the apparatus illustrated in FIG. 11;

FIG. 12b schematically illustrates a graph representing a first data profile derived from the intensity versus wavelength profile illustrated in FIG. 12b;

FIG. 13 schematically illustrates a still further particular arrangement and mode of operation of the apparatus according to one or more embodiments of the present invention;

FIG. 14 schematically illustrates another particular arrangement and mode of operation of the apparatus according to one or more embodiments of the present invention; and

FIG. 15 illustrates the first data profile of a multilayer polymer film substrate tested using the particular arrangement of the apparatus illustrated in FIG. 14.

### DETAILED DESCRIPTION

Providing a taggant material in one or more layers within the body of a film substrate comprises one technique for producing film substrates which may not be copied easily by counterfeiters.

Therefore, while authentication apparatus of a type as described above have been satisfactory and may continue to be satisfactory in certain instances, the applicant has recognised that it would be desirable to provide an ability to discriminate and/or distinguish between film substrate types in which a taggant material is contained in a surface coating and film substrate types in which a taggant material is contained within one or more layers in the body of the film substrate.

The applicant has recognised that another technique which may make the production of counterfeits more difficult is to produce a multilayer film substrate in which each layer has a specific thickness. Replicating the exact thicknesses and the sequence of layers in a multilayer film substrate may prove difficult for a counterfeiter. Again, however, this may not be an insurmountable problem for a determined counterfeiter. Therefore, the applicant has recognised that it would also be desirable to provide an ability to determine a structure of a multilayer film substrate, e.g. determining thicknesses of each layer forming the multilayer film substrate and/or a depth of particular layers from a surface or surfaces of the multilayer film substrate and/or a sequence of layers in a multilayer film substrate.

One or more embodiments of the present invention have been devised with the foregoing considerations in mind.

According to an aspect of the present invention, there is provided an apparatus for indicating if a security document comprises one or more specified characteristics, said apparatus comprising:

an effect sensing device operative to:
(i) sense at least one of:
   a) a stimulated effect arising due to:
      i. an interaction of a plurality of energy carrying particles and/or waves with a passive taggant material in said at least one reference layer; and
      ii. an interaction of a plurality of energy carrying particles and/or waves with an interface between said at least one reference layer and at least one adjacent layer; and
   b) a spontaneous effect arising due to spontaneous emission of a plurality of energy carrying particles and/or waves from an active taggant material in said at least one reference layer; and
(ii) output, to a processor of said apparatus, a sensed effect profile representative of said spontaneous and/or stimulated effect as sensed;

wherein said processor is arranged to:

derive a first data profile from said sensed effect profile;

compare said first data profile with a second data profile representative of a specified effect profile; and

produce an authentication signal representative of a match or otherwise between said first data profile and said second data profile.

The spontaneous and/or stimulated effect may be influenced by: a property of at least one reference layer in a multilayer polymer film substrate of the security document; and a location of the at least one reference layer relative to other layers within the multilayer polymer film substrate.

The present invention may allow a multilayer polymer film substrate forming part of a security document (and thus the security document itself) to be verified as genuine or otherwise. The first data profile (derived from a sensed effect) is compared to a second data profile representative of a specified effect. If the sensed effect as represented in the first data profile matches the specified effect as represented in the second data profile, then the apparatus can provide an indication that the security document being tested is genuine (based upon the authentication signal). From this indication, a determination of authenticity of the security document (i.e. that the document is genuine or otherwise) can be made.

The effect may be indicative/representative of one or more properties of at least one reference layer located within the body of the multilayer polymer film substrate (and the location of that reference layer within the body of the multilayer polymer film substrate).

A counterfeiter may attempt to produce a multilayer polymer film substrate which, when tested, produces an effect that mimics the effect attributable to the one or more properties of the at least one reference layer of a genuine film substrate. The counterfeiter may try to achieve this by providing a coating on a film substrate where the coating has properties which, when the film substrate is tested, give rise to a same effect as is observed when a genuine film substrate is tested. The apparatus of one or more embodiments of the present invention may not be deceived by counterfeit film substrates of this nature. This is because the apparatus is operative to provide an indication which allows a determination to be made that the portion of the film substrate which gives rise to the sensed effect is a layer of the film substrate (i.e. a layer within the body of the film substrate) rather than a coating formed on a surface of the film substrate. Therefore, counterfeit film substrates in which a surface coating is provided in an attempt to mimic a genuine at least one reference layer of a genuine film substrate may be identifiable as counterfeit using the apparatus and method of one or more embodiments of the present invention.

In identifying whether or not a film is genuine or counterfeit, a consideration is made regarding whether or not the film comprises a layer having particular specified properties (e.g. thickness and/or the presence of a taggant material) and if that layer is located within the body of the film (i.e. not a coating) at a particular specified depth.

Optionally, the apparatus may further comprise an energy carrier source device arranged to direct a plurality of energy carrier particles and/or waves at the substrate to bring about the stimulated effect.

Optionally, the effect sensing device comprises an electro-magnetic radiation detector arranged to sense the spontaneous effect through sensing intensity of electro-magnetic radiation received due to spontaneous emission of electro-magnetic radiation from the active taggant material in the at least one reference layer.

Optionally, the energy carrier source device comprises an electro-magnetic radiation emitter arranged to irradiate the multilayer polymer film with electro-magnetic radiation.

Optionally, the effect sensing device comprises an electro-magnetic radiation detector arranged to:

a) sense the stimulated effect through sensing at least one of:

(i) intensity of electro-magnetic radiation reflected from interfaces between adjacent layers of the multilayer polymer film and/or as intensity of electro-magnetic radiation transmitted through said multilayer polymer film; and

(ii) intensity of electro-magnetic radiation received due to stimulated emission of electro-magnetic radiation from the passive taggant material in the at least one reference layer caused by stimulation by irradiating electro-magnetic radiation from the electro-magnetic emitter; and

b) output the sensed effect profile as a sensed intensity profile to the processor.

Optionally, the processor may be arranged to derive the first data profile by relating the sensed intensity profile to wavelength of the reflected electro-magnetic radiation and masking a portion of the sensed intensity profile over a particular range of wavelengths. Further optionally, the processor may be arranged to: compare the first and second data profiles to determine if a peak corresponding to a particular wavelength, or a particular wavelength range, of reflected electro-magnetic radiation in the first data profile corresponds to a peak corresponding to a specified wavelength, or a specified wavelength range, of the second data profile; and output a positive authentication signal if the peak in the first data profile matches the peak in the second data profile. Yet further optionally, the processor may be arranged to: determine that a first end point of the particular wavelength range in which the peak occurs in the first data profile is representative of an interface between a surface of a non-reference layer and a first surface of the reference layer, and that a second end point of the particular wavelength range in which the peak occurs in the first data profile is representative of an interface between a second surface of the reference layer and a surface of another non-reference layer.

Optionally, the processor may be arranged to determine from the first and second end points of the particular wavelength range: a depth of the interface between the surface of the non-reference layer and the first surface of the reference layer; a depth of the interface between the second surface of the reference layer and the surface of the other non-reference layer; and a thickness of the reference layer from a difference between the depth of each interface.

Optionally, the processor may be further arranged to derive the first data profile by transforming, using a transformation function algorithm, the sensed intensity profile into a frequency domain profile comprising a data profile of power spectral density versus thickness. Further optionally, the processor may be arranged to: compare the first and second data profiles to determine if a peak or peaks in the frequency domain profile of the first data profile correspond to a peak or peaks in a frequency domain profile of the second data profile; and output a positive authentication signal if the peak or peaks in the frequency domain profile of the first data profile match peak or peaks in the frequency domain profile of the second data profile. Yet further optionally, the processor may be arranged to: mask a portion of the frequency domain profile of the first data profile and mask a corresponding portion of the frequency domain profile of the second data profile; compare unmasked portions of the first and second data profiles to determine if a peak or peaks in an unmasked portion of the frequency domain profile of the first data profile correspond to a peak or peaks in an unmasked portion of the frequency domain profile of the second data profile; and output a positive authentication signal if the peak or peaks in the unmasked portion of the frequency domain profile of the first data profile match peak or peaks in the unmasked portion of the frequency domain profile of the second data profile.

Optionally, the processor may be arranged to calculate a distance of the one or more reference layers from upper and/or lower surfaces of the multilayer polymer film substrate and/or a thickness of the one or more reference layers.

Optionally, the processor may be arranged to determine that: a position of the peak or peaks in the frequency domain profile of the first data profile is representative of at least: a depth of an interface between a surface of a first layer and a first surface of a second layer; and a depth of an interface between a second surface of the second layer and a surface of a third layer; and a thickness of the second layer. Further optionally, the processor may be arranged to determine from the peak or peaks in the unmasked portion of the frequency domain profile of the first data profile: a depth of the interface between the surface of the first layer and the first surface of the second layer; a depth of the interface between the second surface of the second layer and the surface of the third layer; a thickness of the second layer from a difference between the depth of each interface; and that the second layer comprises the reference layer based upon a comparison of, and match between, the determined depth and thickness values and specified depth and thickness values.

Optionally, the transformation function algorithm implemented by the processor may comprise a fast Fourier transform.

Optionally the electro-magnetic radiation detector may comprise an array of sub-detectors in which: at least one sub-detector is configured to detect for the stimulated effect by detecting for electro-magnetic radiation reflected from a first depth within the multilayer polymer film; and at least one other sub-detector is configured to detect for the stimulated effect by detecting for electro-magnetic radiation reflected from at least one other depth within the multilayer polymer film; the detector arranged to output the sensed effect profile as an intensity measurement profile to the processor, and wherein the processor may be arranged to: collate intensity measurements output from each of the sub-detectors; and assign a sub-detector indication reference to each intensity measurement based upon a respective sub-detector which provided the intensity measurement.

Optionally, the processor may be arranged to derive the first data profile by: noting, from the sub-detector indication reference, the at least one sub-detector at which reflected electro-magnetic radiation is received; and determining, for each beam of reflected electro-magnetic radiation received, a depth of each interface between adjacent layers giving rise to each the beam of reflected electro-magnetic radiation; the determination based upon: a spacing between the sub-detector at which a particular beam of reflected electro-magnetic radiation is received and the electro-magnetic radiation emitter; and a spacing between the sub-detector and a reference point in the detector array.

Optionally, the electro-magnetic radiation emitter may be arranged to irradiate the multilayer polymer film with at least two beams of electro-magnetic radiation emitted at different angles; and further wherein: at least a first one of the at least one sub-detectors is configured to detect for the stimulated effect by detecting for a first of the at least two beams of electro-magnetic radiation reflected from the first depth within the multilayer polymer film; at least a second one of the at least one sub-detectors is configured to detect for the stimulated effect by detecting for a second of the at least two beams of electro-magnetic radiation reflected from the first depth within the multilayer polymer film; at least a third one of the at least one sub-detectors is configured to detect for the stimulated effect by detecting for the first of the at least two beams of electro-magnetic radiation reflected from the at least one other depth within the multilayer polymer film; at least a fourth one of the at least one sub-detectors is configured to detect for the stimulated effect by detecting for the second of the at least two beams of electro-magnetic radiation reflected from the at least one other depth within the multilayer polymer film; the detector arranged to output the sensed effect profile as an intensity measurement profile to the processor, and wherein the processor may be arranged to: collate intensity measurements output from each of the sub-detectors; and assign a sub-detector indication reference to each intensity measurement based upon a respective sub-detector which provided the intensity measurement.

Optionally, the processor may be arranged to derive the first data profile by: noting, from the sub-detector indication reference, at least two sub-detectors at which reflected electro-magnetic radiation is received; and determining, for each received reflection of an electro-magnetic radiation beam emitted at a first angle and at a different angle, a depth of each interface between adjacent layers giving rise to each received reflection of an electro-magnetic radiation beam emitted at the first angle and at the different angle; the determination based upon a spacing between: a first sub-detector at which is received a particular reflection, from a particular interface, of an electro-magnetic radiation beam emitted at a first angle; and a second sub-detector at which is received a particular reflection, from the same particular interface, of an electro-magnetic radiation beam emitted at a second.

Optionally, the processor may be arranged to: compare the first data profile comprising interface depth data with the second data profile which comprises data identifying specified interface depths to determine if interface depth data of the first data profile corresponds to data identifying specified interface depths of the second data profile; and output a positive authentication signal if the interface depth data of the first data profile matches data identifying specified interface depths of the second data profile.

Optionally, the processor may be further arranged to: calculate a thickness of each layer in the multilayer polymer film from the first data profile comprising interface depth data; and calculate a depth of first and/or second surfaces of each the layer from first and/or second surfaces of the multilayer polymer film.

Optionally, the apparatus may further comprise focusing optics controllable to focus an irradiating electro-magnetic radiation beam emitted by the electro-magnetic radiation emitter to a focal point at a particular depth, and further wherein the electro-magnetic radiation detector may be arranged to: sense the stimulated effect through sensing intensity of electro-magnetic radiation emitted from the focal point as a result of stimulation by the irradiating electro-magnetic radiation beam; and output the sensed effect profile as a sensed intensity profile to the processor.

Optionally, the processor may be arranged to: control movement of the focussing optics over a movement range to move a focal point position through a plurality of different positions corresponding to the movement range; and compile the first data profile from a plurality of sensed intensity profiles received from the electro-magnetic radiation detector corresponding to the plurality of different positions of the focal point.

Optionally, the processor may be arranged to: compare the first data profile with the second data profile which comprises data identifying a specified intensity profile for the plurality of different focal point positions to determine if the first data profile corresponds to the specified intensity profile of the second data profile; and output a positive authentication signal if the first data profile matches the specified intensity profile of the second data profile.

Optionally, the processor may be arranged to: determine if an intensity value of the first data profile increases above and/or decreases below a specified threshold intensity value; determine that any the increase from a position below, to a position above the specified threshold intensity value, or vice versa, due to a change in focal point position, is indicative of the focal point position changing from a position at one side of an interface between two adjacent layers to a position at an opposite side of the interface.

Optionally, the processor may be arranged to: determine that an increase from a position below, to a position above the specified threshold intensity value is indicative of the focal point position changing from a position in a non-reference layer of the multilayer polymer film to a position in a reference layer containing a stimulable taggant; and determine that a decrease from a position above, to a position below the specified threshold intensity value is indicative of the focal point position changing from a position in the reference layer containing the stimulable taggant to a position in the non-reference layer of the multilayer polymer film.

Optionally, the processor may be arranged to calculate, from the first data profile: a thickness of the reference layer in the multilayer polymer film; and a depth of first and/or second surfaces of the reference layer from first and/or second surfaces of the multilayer polymer film; by determining focal point positions at which the increase from a position below, to a position above the specified threshold intensity value, or vice versa, occurs.

Optionally, the processor may be arranged to compile the first data profile from at least: a sensed intensity profile received from the electro-magnetic radiation detector corresponding to electro-magnetic radiation emitted from the at least one reference layer; and a sensed intensity profile received from the electro-magnetic radiation detector corresponding to transmission of electro-magnetic radiation transmitted through the multilayer polymer film.

Optionally, the processor may be arranged to: compare the first data profile with the second data profile which comprises data identifying a specified intensity profile for a multilayer polymer film containing a taggant material in a reference layer at a particular depth; determine if the first data profile corresponds to the specified intensity profile of the second data profile; and output a positive authentication signal if the first data profile matches the specified intensity profile of the second data profile.

Optionally, the processor may be to calculate a thickness of the reference layer in the multilayer polymer film and a depth of first and/or second surfaces of the reference layer from first and/or second surfaces of the multilayer polymer film from intensity values of the first data profile corresponding to: electro-magnetic radiation emitted from the first surface of the multilayer polymer film; electro-magnetic radiation emitted from the second surface of the multilayer polymer film; and electro-magnetic radiation transmitted through the multilayer polymer film. Further optionally, the processor may be arranged to implement the calculation using Beer-Lambert's law.

Optionally, the effect sensing device may be arranged to: sense the stimulated effect through noting a time of reception of a reflection beam of a or the plurality of energy carrying particles and/or waves from interfaces between adjacent layers of the multilayer polymer film; and output the sensed effect profile as a noted time profile to the processor.

Optionally, the processor may be arranged to derive the first data profile by: noting a time at which an irradiating beam is directed into the multilayer polymer film by the energy carrier source device; noting, for each received reflection beam, a time of receipt of each the reflection beam; determining an elapsed time from issue of the irradiating beam to receipt of at least one reflection beam from a difference between the time at which the irradiating beam is directed into the multilayer polymer film by the energy carrier source device and the time of receipt of the at least one reflection beam; determining an elapsed time from issue of the irradiating beam to receipt of at least one other reflection beam from a difference between the time at which the irradiating beam is directed into the multilayer polymer film by the energy carrier source device and the time of receipt of the at least one other reflection beam.

Optionally, the processor may be arranged to: compare the first and second data profiles to determine if the elapsed time from issue of the irradiating beam to receipt of the at least one reflection beam and receipt of the at least one other reflection beam correspond to specified elapsed times of the second data profile; and output a positive authentication signal if the elapsed times in the first data profile match corresponding ones in the second data profile.

Optionally, the processor may be arranged to calculate a thickness of the reference layer in the multilayer polymer film and a depth of first and/or second surfaces of the reference layer from first and/or second surfaces of the multilayer polymer film from elapsed time values of the first data profile corresponding to an elapsed time from issue of the irradiating beam to times of receipt of at least two of: receipt of a reflection beam from the first surface of the reference layer; receipt of a reflection beam from the second surface of the reference layer; receipt of a reflection beam from the first surface of the multilayer polymer film substrate; and receipt of a reflection beam from the second surface of the multilayer polymer film substrate.

Optionally, the effect sensing device may be arranged to: sense the stimulated effect through noting a time of receipt of a transmission beam of the plurality of energy carrying particles and/or waves as transmitted through the multilayer polymer film from the energy carrier source device; and output the sensed effect profile as a noted time profile to the processor.

Optionally, the processor may be arranged to derive the first data profile by: noting a time at which an irradiating beam is directed into the multilayer polymer film by the energy carrier source device; noting, for a received transmission beam, a time of receipt of the transmission beam; determining an elapsed time from issue of the irradiating beam to receipt of the transmission beam from a difference between the time at which the irradiating beam is directed into the multilayer polymer film by the energy carrier source device and the time of receipt of the transmission beam.

Optionally, the processor may be arranged to: compare the first and second data profiles to determine if the elapsed time from issue of the irradiating beam to receipt of the transmission beam corresponds to a specified elapsed time of the second data profile; and output a positive authentication signal if the elapsed time in the first data profile matches a corresponding one in the second data profile.

Optionally, the processor may be arranged to calculate a thickness of the multilayer polymer film substrate from elapsed time values of the first data profile corresponding to an elapsed time from issue of the irradiating beam to receipt of a transmission beam transmitted through the multilayer polymer film substrate.

Optionally, the plurality of energy carrying particles and/or waves may comprise photons. Further optionally, the plurality of energy carrying particles and/or waves may comprise, or may further comprise phonons. Yet further optionally, the energy carrier source device may comprise, or may further comprise, an acoustic emission device, and the effect sensing device may comprise, or may further comprise, an acoustic detector.

According to another aspect of the present invention, there is provided a method of determining if a security document comprises one or more specified characteristics, said method comprising:

sensing at least one of:

(a) a stimulated effect arising due to:

i. an interaction of a plurality of energy carrying particles and/or waves with a passive taggant material in said at least one reference layer; and

ii. an interaction of a plurality of energy carrying particles and/or waves with an interface between said at least one reference layer and at least one adjacent layer; and

(b) a spontaneous effect arising due to spontaneous emission of a plurality of energy carrying particles and/or waves from an active taggant material in said at least one reference layer; and

(ii) outputting, from an effect sensing device to a processor, a sensed effect profile representative of said spontaneous and/or stimulated effect as sensed;

(iii) deriving, in said processor, a first data profile from said sensed effect profile;

(iv) comparing, in said processor, said first data profile with a second data profile representative of a specified effect profile; and

(v) producing, from said processor, an authentication signal representative of a match or otherwise between said first data profile and said second data profile.

Optionally, the method may comprise directing, from an energy carrier source device, a plurality of energy carrier particles and/or waves at the substrate to bring about the stimulated effect.

Optionally, the method may further comprise sensing the spontaneous effect through sensing intensity of electro-magnetic radiation received due to spontaneous emission of electro-magnetic radiation from the active taggant material in the at least one reference layer.

Optionally, the method may further comprise irradiating the multilayer polymer film with electro-magnetic radiation.

Optionally, the method may further comprise:

a) sensing the stimulated effect through sensing at least one of:

(i) intensity of electro-magnetic radiation reflected from interfaces between adjacent layers of the multilayer polymer film and/or as intensity of electro-magnetic radiation transmitted through the multilayer polymer film; and

(ii) intensity of electro-magnetic radiation received due to stimulated emission of electro-magnetic radiation from the passive taggant material in the at least one reference layer; and

b) outputting the sensed effect profile as a sensed intensity profile to the processor.

Optionally, the method may comprise deriving, in the processor, the first data profile by relating the sensed intensity profile to wavelength of the reflected electro-magnetic radiation and masking a portion of the sensed intensity profile over a particular range of wavelengths.

Optionally, the method may comprise: comparing the first and second data profiles to determine if a peak corresponding to a particular wavelength, or a particular wavelength range, of reflected electro-magnetic radiation in the first data profile corresponds to a peak corresponding to a specified wavelength, or a specified wavelength range, of the second data profile; and outputting a positive authentication signal if the peak in the first data profile matches the peak in the second data profile.

Optionally, the method may comprise determining that a first end point of the particular wavelength range in which the peak occurs in the first data profile is representative of an interface between a surface of a non-reference layer and a first surface of the reference layer, and that a second end point of the particular wavelength range in which the peak occurs in the first data profile is representative of an interface between a second surface of the reference layer and a surface of another non-reference layer.

Optionally, the method may comprise determining from the first and second end points of the particular wavelength range: a depth of the interface between the surface of the non-reference layer and the first surface of the reference layer; a depth of the interface between the second surface of the reference layer and the surface of the other non-reference layer; and a thickness of the reference layer from a difference between the depth of each interface.

Optionally, the method may comprise deriving the first data profile by transforming, using a transformation function algorithm, the sensed intensity profile into a frequency domain profile comprising a data profile of power spectral density versus thickness.

Optionally, the method may comprise: comparing the first and second data profiles to determine if a peak or peaks in the frequency domain profile of the first data profile correspond to a peak or peaks in a frequency domain profile of the second data profile; and outputting a positive authentication signal if the peak or peaks in the frequency domain profile of the first data profile match peak or peaks in the frequency domain profile of the second data profile.

Optionally, the method may comprise: masking a portion of the frequency domain profile of the first data profile and masking a corresponding portion of the frequency domain profile of the second data profile; comparing unmasked portions of the first and second data profiles to determine if a peak or peaks in an unmasked portion of the frequency domain profile of the first data profile correspond to a peak or peaks in an unmasked portion of the frequency domain profile of the second data profile; and outputting a positive authentication signal if the peak or peaks in the unmasked portion of the frequency domain profile of the first data profile match peak or peaks in the unmasked portion of the frequency domain profile of the second data profile.

Optionally, the method may comprise determining that: a position of the peak or peaks in the frequency domain profile of the first data profile is representative of at least: a depth of an interface between a surface of a first layer and a first surface of a second layer; and a depth of an interface between a second surface of the second layer and a surface of a third layer; and a thickness of the second layer.

Optionally, the method may comprise determining from the peak or peaks in the unmasked portion of the frequency domain profile of the first data profile: a depth of the interface between the surface of the first layer and the first surface of the second layer; a depth of the interface between the second surface of the second layer and the surface of the third layer; a thickness of the second layer from a difference between the depth of each interface; and that the second layer comprises the reference layer based upon a comparison of, and match between, the determined depth and thickness values and specified depth and thickness values.

Optionally, the method may comprise: detecting, in at least one sub-detector of an array of sub-detectors of an electro-magnetic radiation detector: the stimulated effect by detecting for electro-magnetic radiation reflected from a first depth within the multilayer polymer film; and the stimulated effect by detecting for electro-magnetic radiation reflected from at least one other depth within the multilayer polymer film; outputting the sensed effect profile as an intensity measurement profile to the processor; and collating intensity measurements output from each of the sub-detectors; and assigning a sub-detector indication reference to each intensity measurement based upon a respective sub-detector which provided the intensity measurement.

Optionally, the method may comprise deriving the first data profile by: noting, from the sub-detector indication reference, the at least one sub-detector at which reflected electro-magnetic radiation is received; and determining, for each beam of reflected electro-magnetic radiation received, a depth of each interface between adjacent layers giving rise to each the beam of reflected electro-magnetic radiation; the determination based upon: a spacing between the sub-detector at which a particular beam of reflected electro-magnetic radiation is received and the electro-magnetic radiation emitter; and a spacing between the sub-detector and a reference point in the detector array.

Optionally, the method may comprise: irradiating the multilayer polymer film with at least two beams of electro-magnetic radiation emitted at different angles; detecting, in at least a first one of the at least one sub-detectors, the stimulated effect by detecting for a first of the at least two beams of electro-magnetic radiation reflected from the first depth within the multilayer polymer film; detecting, in at least a second one of the at least one sub-detectors, the stimulated effect by detecting for a second of the at least two beams of electro-magnetic radiation reflected from the first depth within the multilayer polymer film; detecting, in at least a third one of the at least one sub-detectors, the stimulated effect by detecting for the first of the at least two beams of electro-magnetic radiation reflected from the at least one other depth within the multilayer polymer film; detecting, in at least a fourth one of the at least one sub-detectors, the stimulated effect by detecting for the second of the at least two beams of electro-magnetic radiation reflected from the at least one other depth within the multilayer polymer film; outputting the sensed effect profile as an intensity measurement profile to the processor; collating intensity measurements output from each of the sub-detectors; and assigning a sub-detector indication reference to each intensity measurement based upon a respective sub-detector which provided the intensity measurement.

Optionally, the method may comprise deriving the first data profile by: noting, from the sub-detector indication reference, at least two sub-detectors at which reflected electro-magnetic radiation is received; and determining, for each received reflection of an electro-magnetic radiation beam emitted at a first angle and at a different angle, a depth of each interface between adjacent layers giving rise to each received reflection of an electro-magnetic radiation beam emitted at the first angle and at the different angle; the determination based upon a spacing between: a first sub-detector at which is received a particular reflection, from a particular interface, of an electro-magnetic radiation beam emitted at a first angle; and a second sub-detector at which is received a particular reflection, from the same particular interface, of an electro-magnetic radiation beam emitted at a second.

Optionally, the method may comprise: comparing the first data profile comprising interface depth data with the second data profile which comprises data identifying specified interface depths to determine if interface depth data of the first data profile corresponds to data identifying specified interface depths of the second data profile; and outputting a positive authentication signal if the interface depth data of the first data profile matches data identifying specified interface depths of the second data profile.

Optionally, the method may comprise: calculating a thickness of each layer in the multilayer polymer film from the first data profile comprising interface depth data; and calculating a depth of first and/or second surfaces of each the layer from first and/or second surfaces of the multilayer polymer film.

Optionally, the method may comprise: focusing an irradiating electro-magnetic radiation beam emitted by an electro-magnetic radiation emitter to a focal point at a particular depth; sensing the stimulated effect through sensing intensity of electro-magnetic radiation emitted from the focal point as a result of stimulation by the irradiating electro-magnetic radiation beam; and outputting the sensed effect profile as a sensed intensity profile to the processor.

Optionally, the method may comprise: controlling movement of the focussing optics over a movement range to move a focal point position through a plurality of different positions corresponding to the movement range; and compiling the first data profile from a plurality of sensed intensity profiles received from the electro-magnetic radiation detector corresponding to the plurality of different positions of the focal point.

Optionally, the method may comprise: comparing the first data profile with the second data profile which comprises data identifying a specified intensity profile for the plurality of different focal point positions to determine if the first data profile corresponds to the specified intensity profile of the second data profile; and outputting a positive authentication signal if the first data profile matches the specified intensity profile of the second data profile.

Optionally, the method may comprise: determining if an intensity value of the first data profile increases above and/or decreases below a specified threshold intensity value; determining that any the increase from a position below, to a position above the specified threshold intensity value, or vice versa, due to a change in focal point position, is indicative of the focal point position changing from a position at one side of an interface between two adjacent layers to a position at an opposite side of the interface.

Optionally, the method may comprise: determining that an increase from a position below, to a position above the specified threshold intensity value is indicative of the focal point position changing from a position in a non-reference layer of the multilayer polymer film to a position in a reference layer containing a stimulable taggant; and determine that a decrease from a position above, to a position below the specified threshold intensity value is indicative of the focal point position changing from a position in the reference layer containing the stimulable taggant to a position in the non-reference layer of the multilayer polymer film.

Optionally, the method may comprise calculating, from the first data profile: a thickness of the reference layer in the multilayer polymer film; and a depth of first and/or second surfaces of the reference layer from first and/or second surfaces of the multilayer polymer film; by determining focal point positions at which the increase from a position below, to a position above the specified threshold intensity value, or vice versa, occurs.

Optionally, the method may comprise compiling the first data profile from at least: a sensed intensity profile received from an electro-magnetic radiation detector corresponding to electro-magnetic radiation emitted from the at least one reference layer; and a sensed intensity profile received from an electro-magnetic radiation detector corresponding to transmission of electro-magnetic radiation transmitted through the multilayer polymer film.

Optionally, the method may comprise: comparing the first data profile with the second data profile which comprises data identifying a specified intensity profile for a multilayer polymer film containing a taggant material in a reference layer at a particular depth; determining if the first data profile corresponds to the specified intensity profile of the second data profile; and outputting a positive authentication signal if the first data profile matches the specified intensity profile of the second data profile.

Optionally, the method may comprise calculating a thickness of the reference layer in the multilayer polymer film and a depth of first and/or second surfaces of the reference layer from first and/or second surfaces of the multilayer polymer film from intensity values of the first data profile corresponding to: electro-magnetic radiation emitted from the first surface of the multilayer polymer film; electro-magnetic radiation emitted from the second surface of the multilayer polymer film; and electro-magnetic radiation transmitted through the multilayer polymer film.

Optionally, the method may comprise: sensing the stimulated effect through noting a time of reception of a reflection beam of a or the plurality of energy carrying particles and/or waves from interfaces between adjacent layers of the multilayer polymer film; and outputting the sensed effect profile as a noted time profile to the processor.

Optionally, the method may comprise deriving the first data profile by: noting a time at which an irradiating beam is directed into the multilayer polymer film by an energy carrier source device; noting, for each received reflection beam, a time of receipt of each the reflection beam; determining an elapsed time from issue of the irradiating beam to receipt of at least one reflection beam from a difference between the time at which the irradiating beam is directed into the multilayer polymer film and the time of receipt of the at least one reflection beam; determining an elapsed time from issue of the irradiating beam to receipt of at least one other reflection beam from a difference between the time at which the irradiating beam is directed into the multilayer polymer film and the time of receipt of the at least one other reflection beam.

Optionally, the method may comprise: comparing the first and second data profiles to determine if the elapsed time from issue of the irradiating beam to receipt of the at least one reflection beam and receipt of the at least one other reflection beam correspond to specified elapsed times of the second data profile; and outputting a positive authentication signal if the elapsed times in the first data profile match corresponding ones in the second data profile.

Optionally, the method may comprise calculating a thickness of the reference layer in the multilayer polymer film and a depth of first and/or second surfaces of the reference layer from first and/or second surfaces of the multilayer polymer film from elapsed time values of the first data profile corresponding to an elapsed time from issue of the irradiating beam to times of receipt of at least two of: a reflection beam from the first surface of the reference layer; a reflection beam from the second surface of the reference layer; a reflection beam from the first surface of the multilayer polymer film substrate; and a reflection beam from the second surface of the multilayer polymer film substrate.

Optionally, the method may comprise: sensing the stimulated effect through noting a time of receipt of a transmission beam of the plurality of energy carrying particles and/or waves as transmitted through the multilayer polymer film from an energy carrier source device; and outputting the sensed effect profile as a noted time profile to the processor.

Optionally, the method may comprise deriving the first data profile by: noting a time at which an irradiating beam is directed into the multilayer polymer film; noting, for a received transmission beam, a time of receipt of the transmission beam; determining an elapsed time from issue of the irradiating beam to receipt of the transmission beam from a difference between the time at which the irradiating beam is directed into the multilayer polymer and the time of receipt of the transmission beam.

Optionally, the method may comprise: comparing the first and second data profiles to determine if the elapsed time from issue of the irradiating beam to receipt of the transmission beam corresponds to a specified elapsed time of the second data profile; and outputting a positive authentication signal if the elapsed time in the first data profile matches a corresponding one in the second data profile.

Optionally, the method may comprise calculating a thickness of the multilayer polymer film substrate from elapsed time values of the first data profile corresponding to an elapsed time from issue of the irradiating beam to receipt of a transmission beam transmitted through the multilayer polymer film substrate.

According to another aspect of the present invention, there is provided a banknote counting apparatus comprising the apparatus including any one or more of the features defined above, the banknote counting apparatus further comprising a note counting device arranged to maintain a count of banknotes conveyed through the apparatus.

Optionally, the note counting device may be arranged to maintain a count of genuine banknotes conveyed through the apparatus and as identified as genuine banknotes by the apparatus including any one or more of the features defined above. Further optionally, the banknote counting apparatus may be arranged to convey genuine banknotes as identified by the apparatus including any one or more of the features defined above to a first banknote storage position.

According to another aspect of the present invention, there is provided a computer program comprising computer program elements operative in a computer processor to implement one or more aspects of an apparatus including any one or more of the features defined above.

According to another aspect of the present invention, there is provided a computer program comprising computer program elements operative in a computer processor to implement one or more aspects of a method including any one or more of the features defined above.

According to another aspect of the present invention, there is provided a computer readable medium carrying a computer program according as defined above.

According to another aspect of the present invention, there is provided a multilayer polymer film substrate, comprising at least one reference layer for influencing a spontaneous and/or stimulated effect detectable by the apparatus including any one or more of the features defined above.

Optionally, the at least one reference layer may comprise a taggant material for influencing the spontaneous and/or stimulated effect detectable by the apparatus including any one or more of the features defined above.

One or more specific embodiments in accordance with aspects of the present invention will be described, by way of example only, and with reference to the following drawings in which:

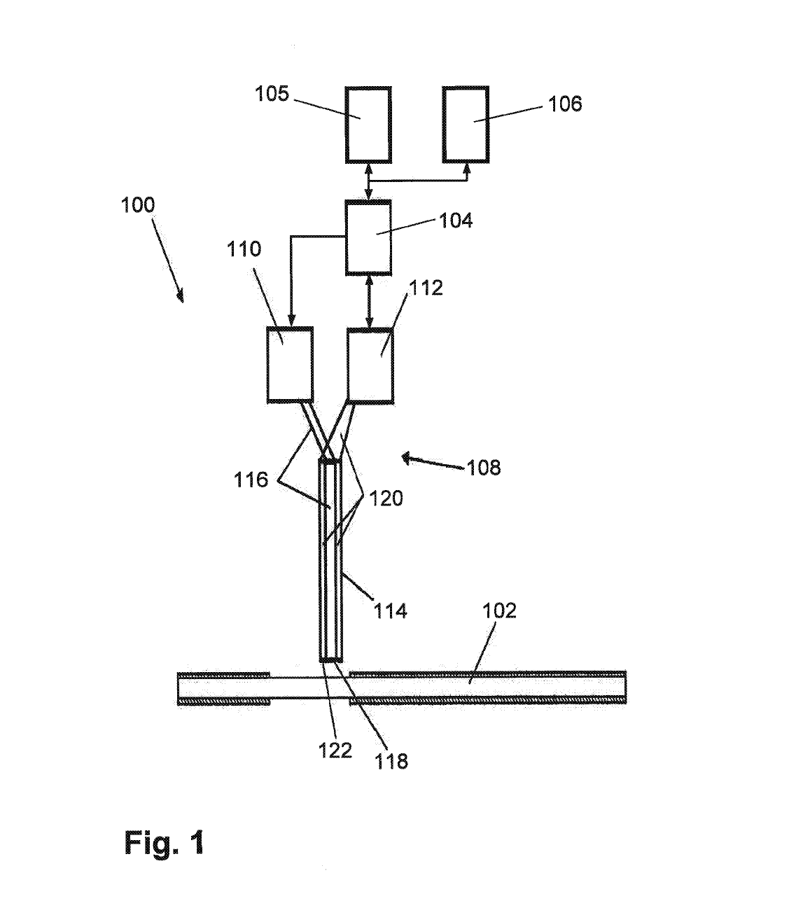

FIG. 1 schematically illustrates an apparatus according to one or more embodiments of the invention;

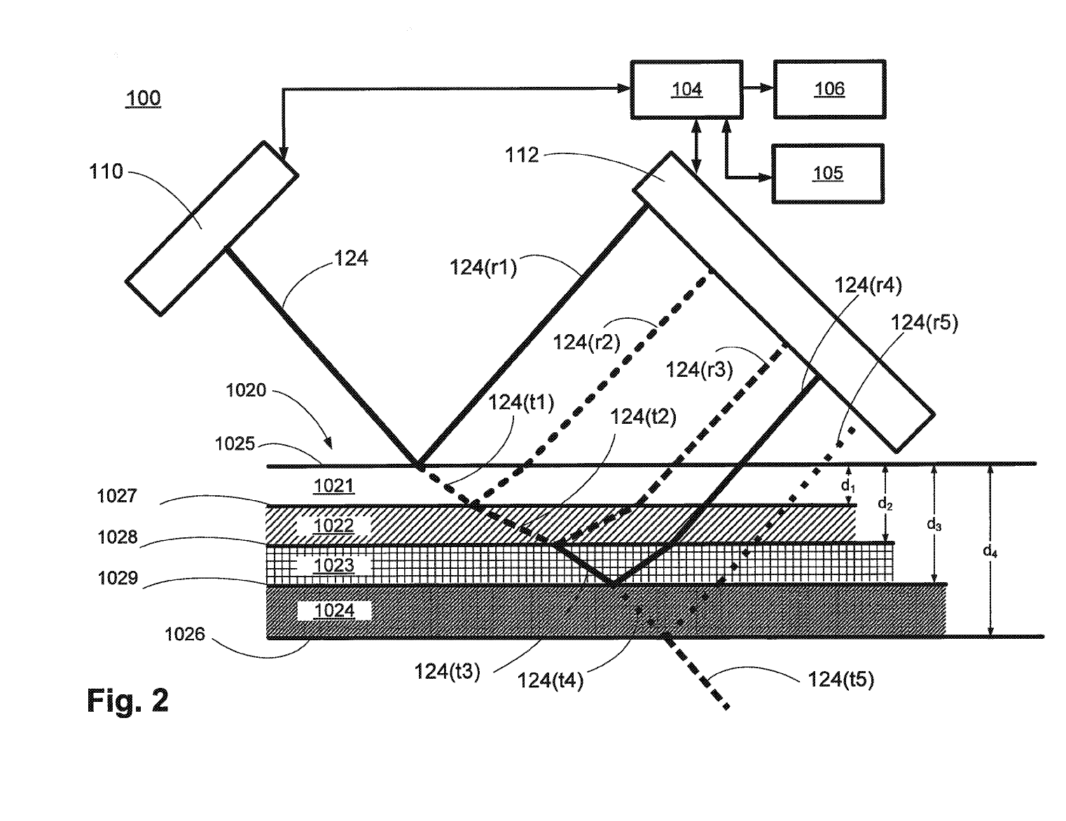

FIG. 2 schematically illustrates a particular arrangement and mode of operation of the apparatus according to one or more embodiments of the present invention;

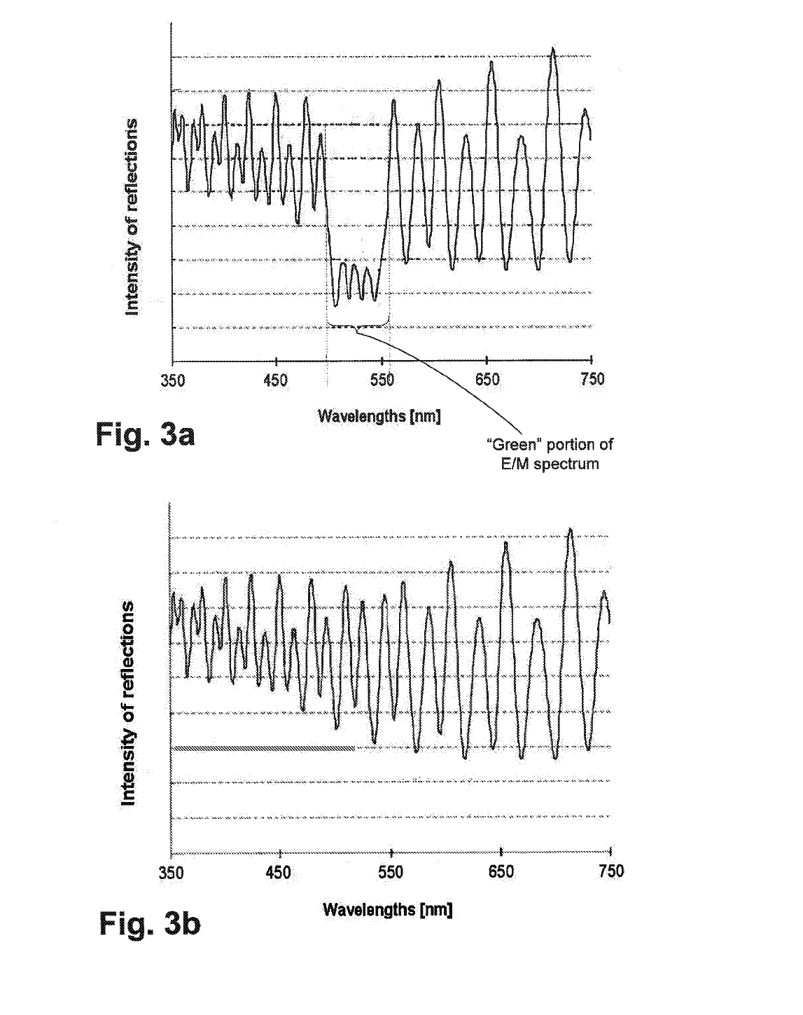

FIGS. 3a and 3b schematically illustrate graphs of measured intensity of reflections versus wavelength for electro-magnetic radiation reflected from different multilayer polymer film substrates;

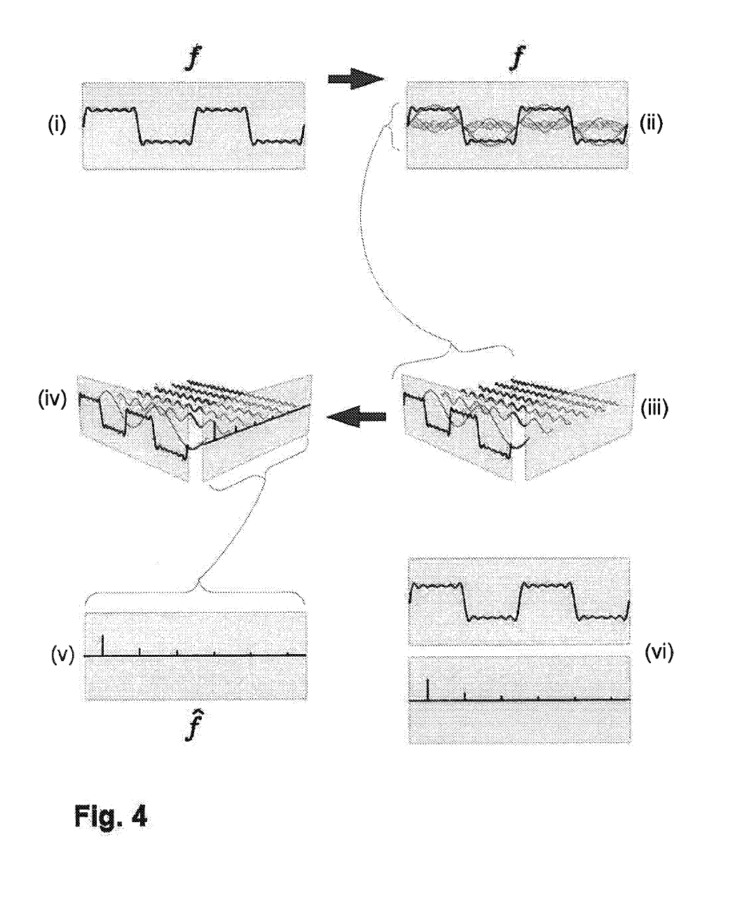

FIG. 4 schematically illustrates a sequence of data processing steps forming part of a transformation function algorithm implemented by a processor of the apparatus in one or more embodiments of the invention to transform the data illustrated in FIG. 3a or 3b to a first data profile;

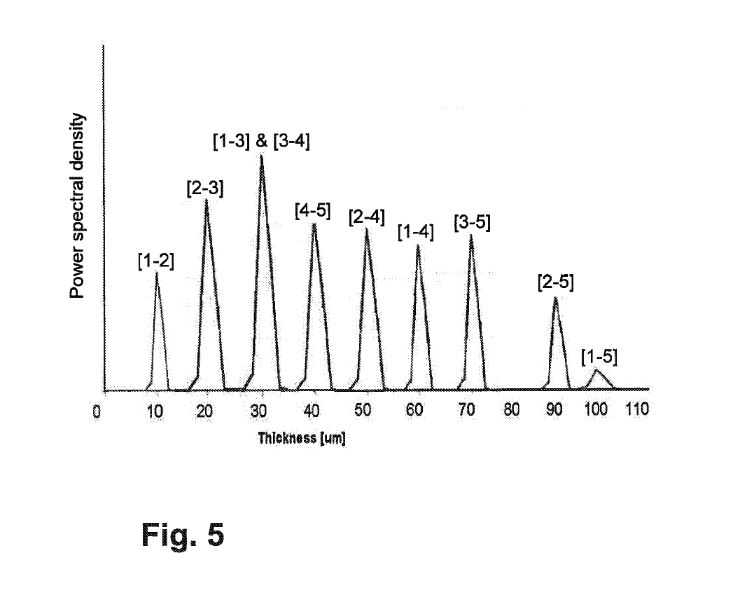

FIG. 5 illustrates the first data profile of a multilayer polymer film substrate tested using the apparatus 100 and obtained from the data of FIG. 3b by employing the transformation function schematically illustrated in FIG. 4;

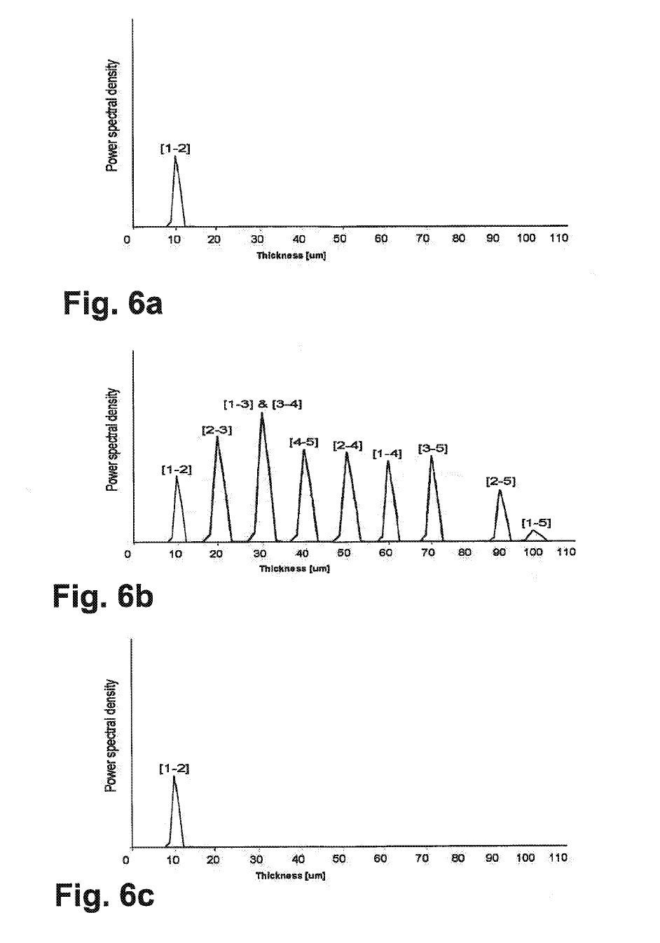

FIG. 6a illustrates a modified specified data profile which is obtained by applying a mask function to an original specified data profile;

FIG. 6b illustrates a modified first data profile for a non-genuine multilayer polymer film where the modified first data profile is obtained by applying the mask function to the first data profile illustrated in FIG. 5;

FIG. 6c illustrates a modified first data profile for a genuine multilayer polymer film where the modified first data profile is obtained by applying the mask function to the first data profile for that genuine multilayer polymer film;

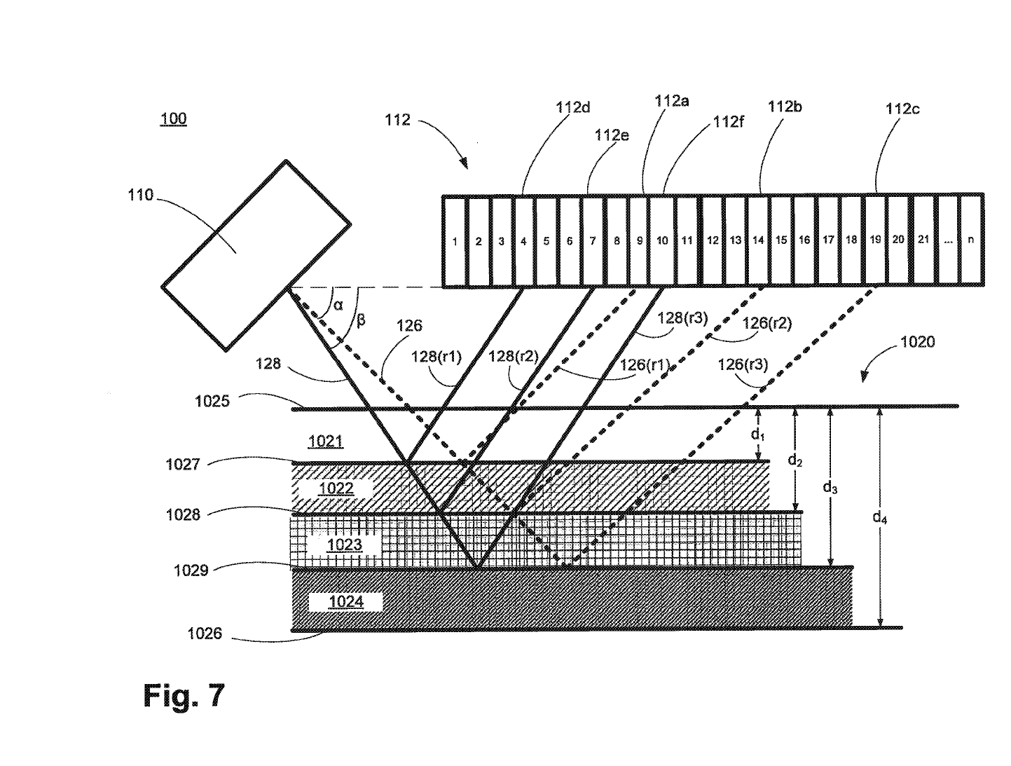

FIG. 7 schematically illustrates another particular arrangement and mode of operation of the apparatus according to one or more embodiments of the present invention;

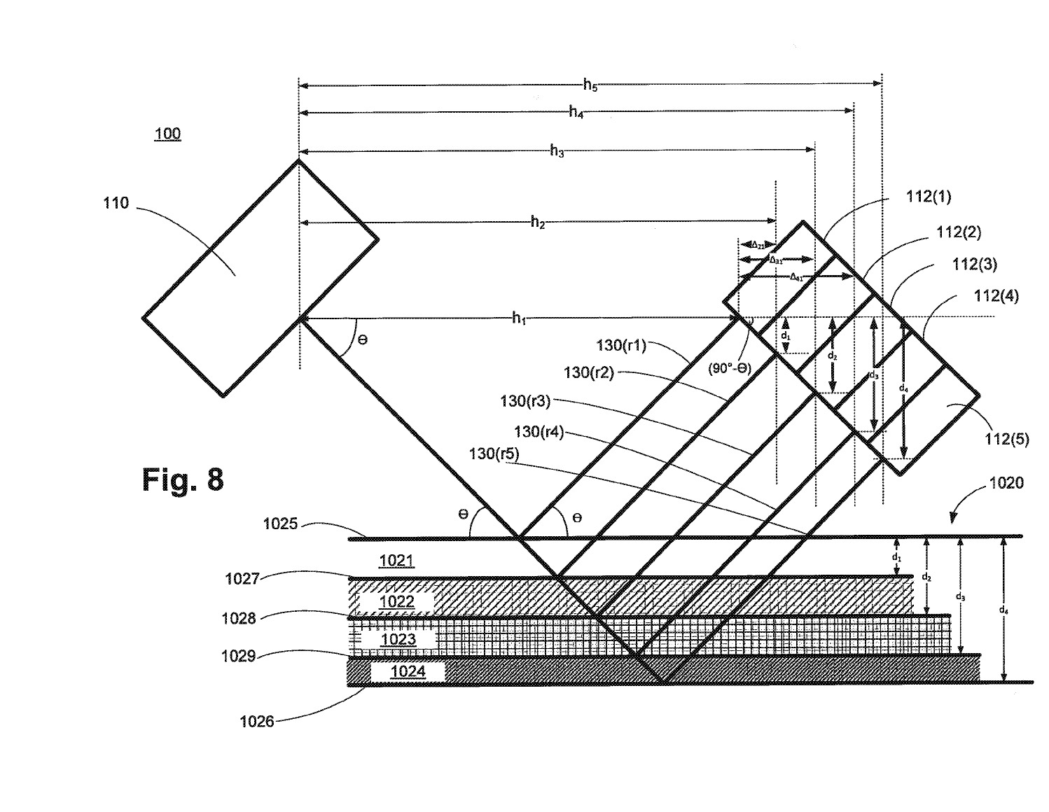

FIG. 8 schematically illustrates yet another particular arrangement and mode of operation of the apparatus according to one or more embodiments of the present invention;

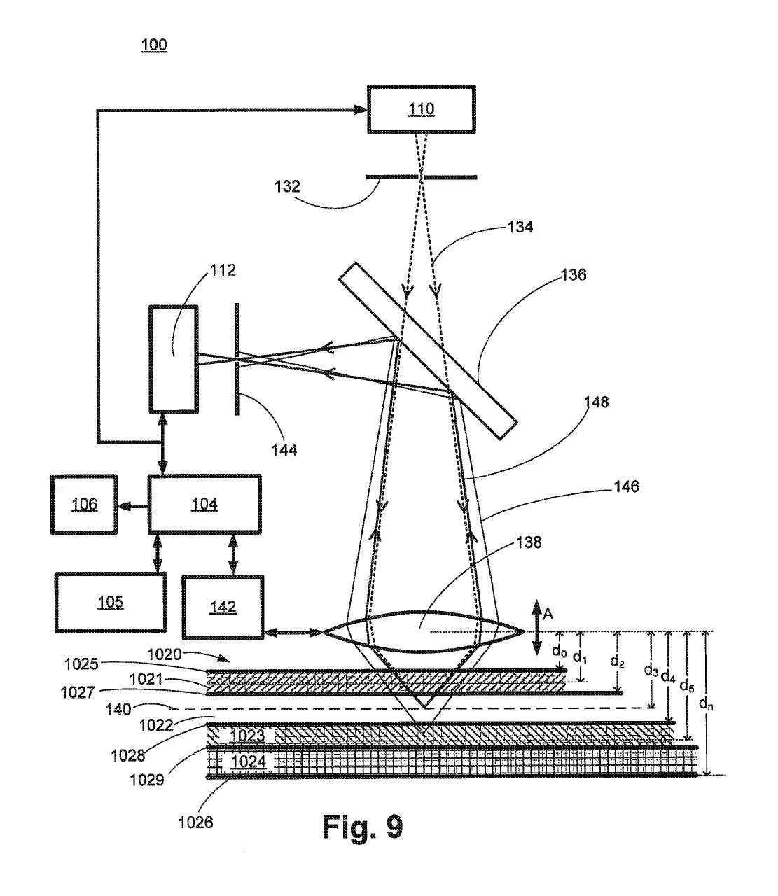

FIG. 9 schematically illustrates a further particular arrangement and mode of operation of the apparatus according to one or more embodiments of the present invention;

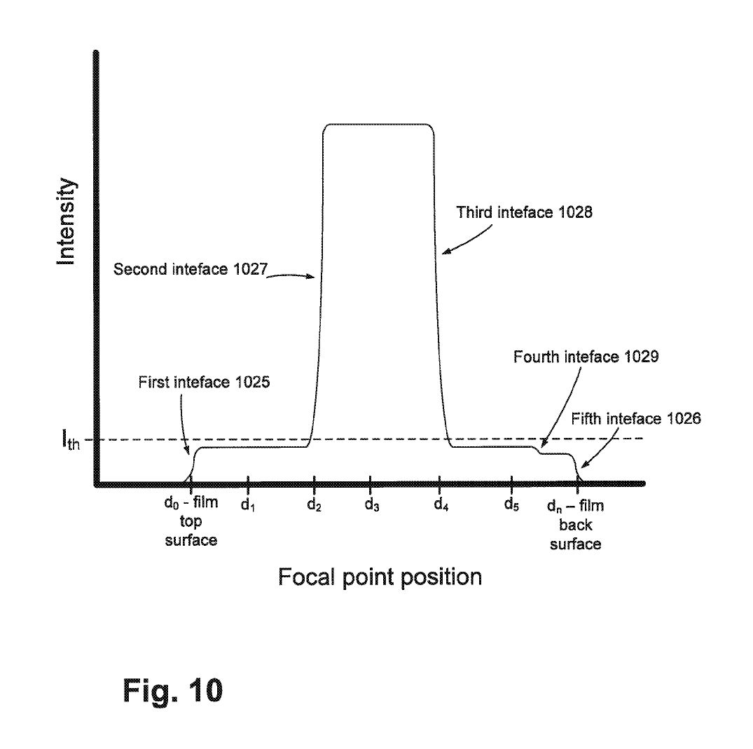

FIG. 10 schematically illustrates a graph of measured intensity versus focal point position for electro-magnetic radiation received from a multilayer polymer film substrate as tested using the particular arrangement of the apparatus illustrated in FIG. 9;

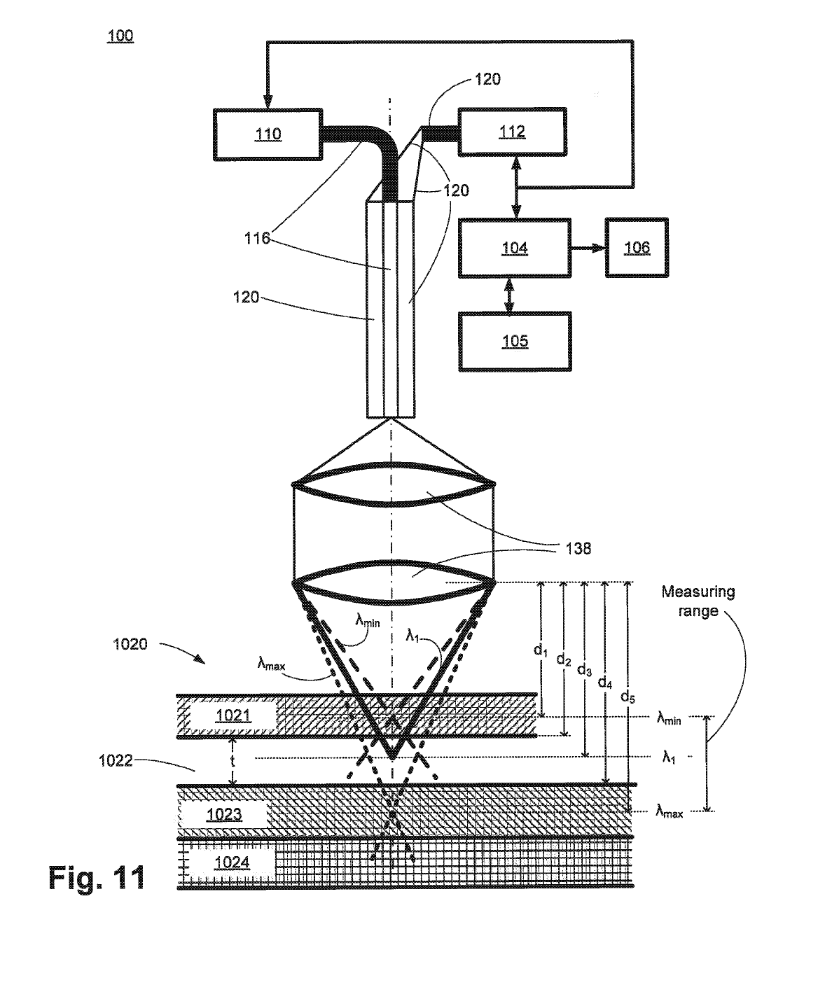

FIG. 11 schematically illustrates a yet further particular arrangement and mode of operation of the apparatus according to one or more embodiments of the present invention;

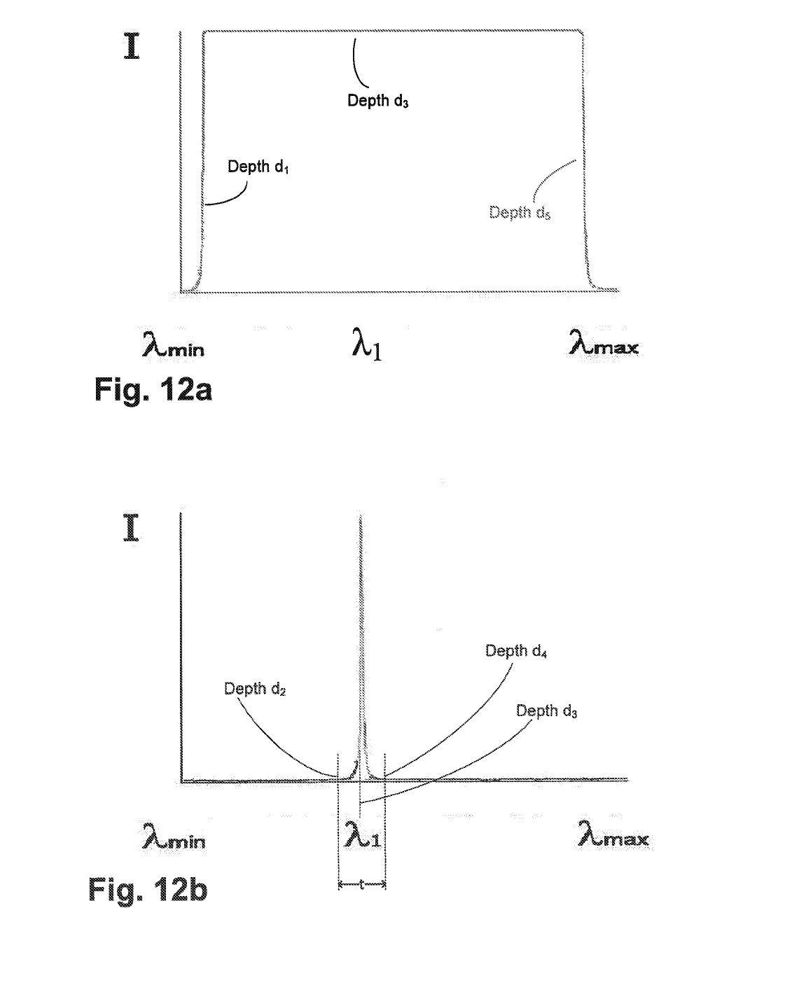

FIG. 12a schematically illustrates a graph of measured intensity versus wavelength for electro-magnetic radiation received from a multilayer polymer film substrate as tested using the particular arrangement of the apparatus illustrated in FIG. 11;

FIG. 12b schematically illustrates a graph representing a first data profile derived from the intensity versus wavelength profile illustrated in FIG. 12b;

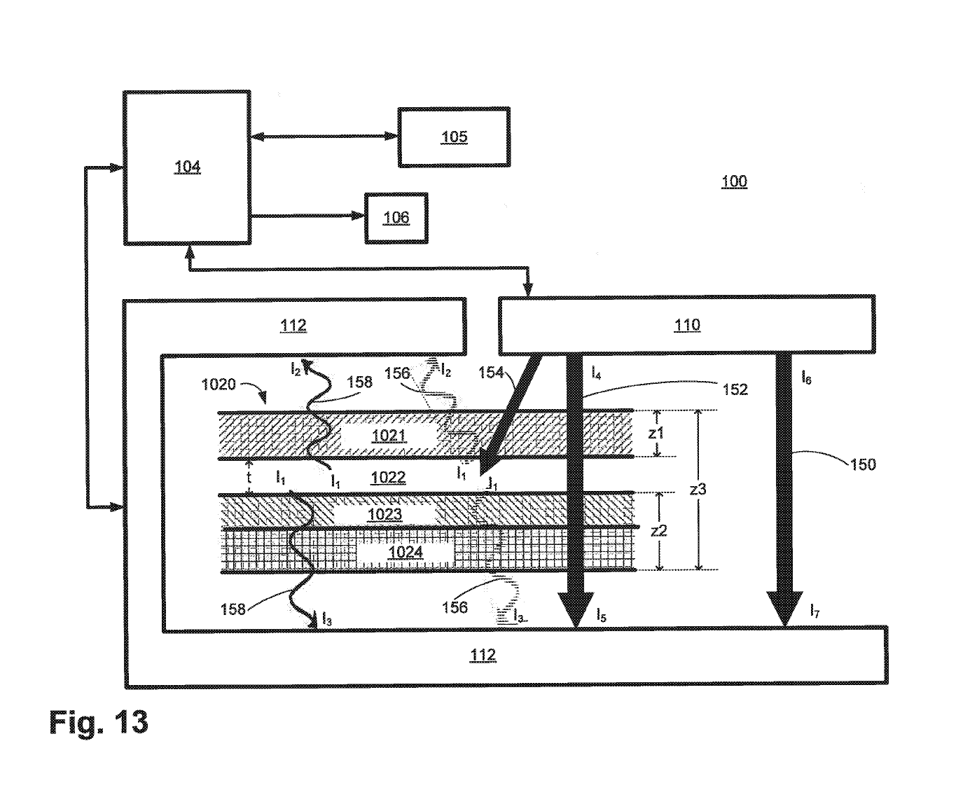

FIG. 13 schematically illustrates a still further particular arrangement and mode of operation of the apparatus according to one or more embodiments of the present invention;

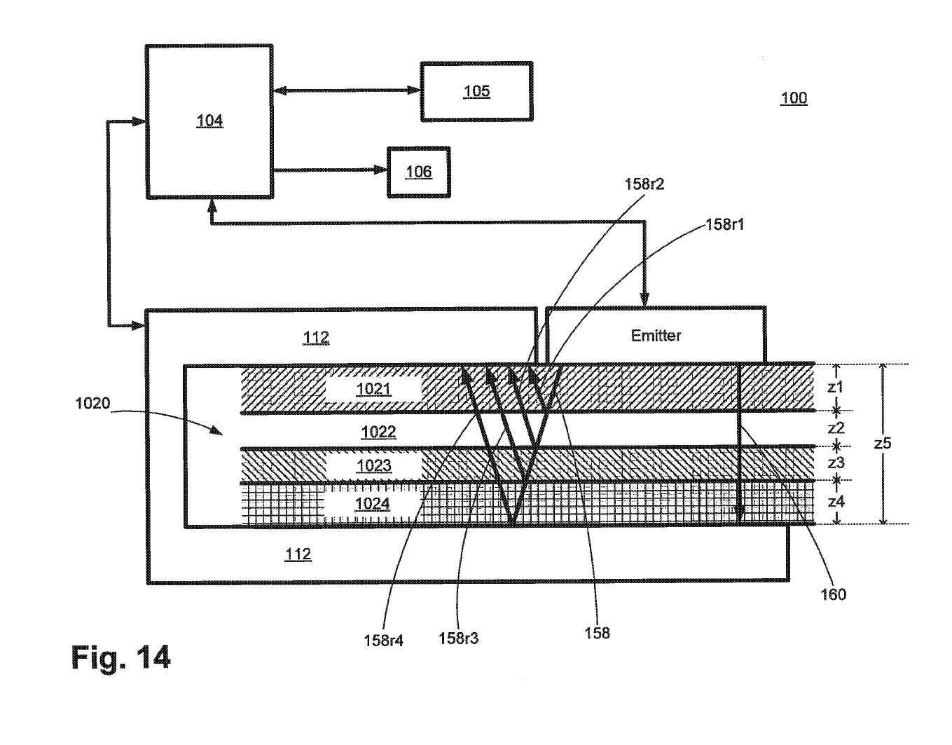

FIG. 14 schematically illustrates another particular arrangement and mode of operation of the apparatus according to one or more embodiments of the present invention; and

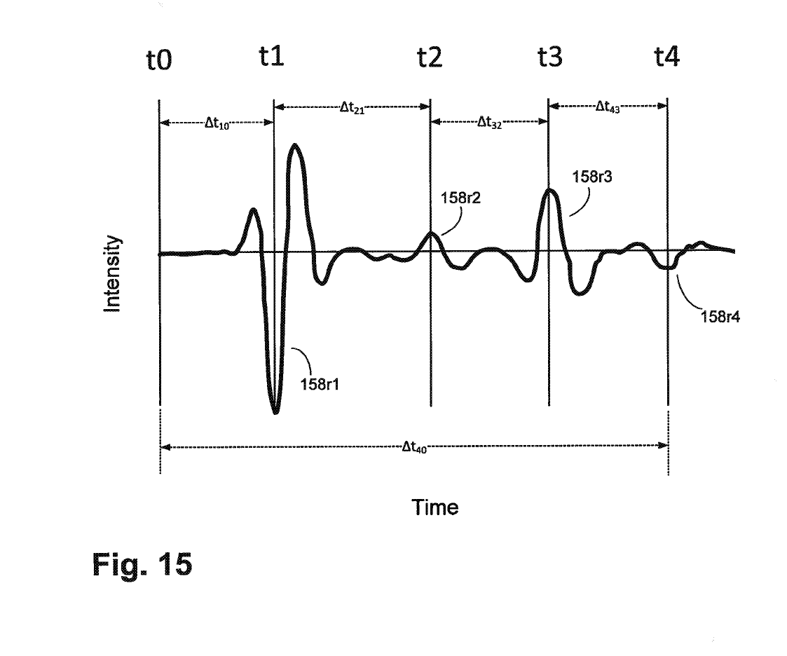

FIG. 15 illustrates the first data profile of a multilayer polymer film substrate tested using the particular arrangement of the apparatus illustrated in FIG. 14.

FIG. 1 illustrates an apparatus 100 according to one or more embodiments of the invention for indicating if an item 102 (e.g. a security document) has one or more specified characteristics. If the item 102 possesses such characteristics, it may be deemed genuine. Otherwise, the item may be deemed counterfeit or non-authentic.

The apparatus 100 comprises a processor 104 arranged to generate a signal indicative of the detection of either a genuine or counterfeit security document. Such a signal is communicated to an authenticity indication unit 106 which, responsive to receipt of such signal, is arranged to present an indication of whether or not the security document is authentic or non-genuine.

A positive signal (e.g. a signal indicative of the detection of a genuine security document) is generated in response to the detection of a security document having a number of specified identifying characteristics. The specified identifying characteristics comprise properties which may be discernible acoustically, thermally and/or using techniques which employ electro-magnetic radiation.

The apparatus comprises an effect sensing device arranged to sense a spontaneous effect and/or a stimulated effect, both of which may be influenced by properties of one or more layers of the multilayer polymer film substrate of the security document and by a sequence of layers in the multilayer polymer film substrate. In particular, a sensed effect which matches a specified effect can provide an indirect indication that one or more layers of the multilayer polymer film substrate (i.e. reference layers) have specific properties and locations within the body of the film substrate which are required if the film substrate is to be deemed genuine.

The spontaneous effect may arise due to emission of an energy carrying particle and/or wave from an emission source located in one or more layers of the multilayer polymer film substrate. The stimulated effect may arise due to stimulation of a suitable material located in one or more layers of the multilayer polymer film substrate. Once stimulated, the material may emit energy carrying particles and/or waves. Also, the stimulated effect may arise due to energy carrying particles and/or waves being reflected by one or more interfaces between adjacent layers in the multilayer polymer film.

If, for example, the energy carrying particles and/or waves detected by the effect sensing device:

are of specific intensities; and/or

are of a specific wavelength, or range of wavelengths; and/or

arrive at the effect sensing device at a specific time; and/or

arrive at the effect sensing device at a specific location on the effect sensing device, the apparatus may determine that the multilayer polymer film substrate being tested is genuine.

To invoke the stimulated effect, the apparatus may, in one or more embodiments, also comprise an energy carrier source device arranged to direct a plurality of energy carrier particles and/or waves at the multilayer polymer film substrate to stimulate the effect.

In the particular example illustrated in FIG. 1, the effect sensing device and energy carrier source device of apparatus 100 form elements in an optical detection apparatus 108, which functions as a broadband light interferometer and is operable to measure the thickness of a sheet of multilayer polymer film substrate material of the security document 102, and some layers and combinations of layers within the multilayer polymer film substrate.

The optical detection apparatus 108 comprises an electro-magnetic radiation emitter 110 as the energy carrier source device. The electro-magnetic radiation emitter 110 functions as a broadband source of electro-magnetic radiation (e.g. a white light emitter). The optical detection apparatus also comprises an electro-magnetic radiation detector 112 (optionally a photodiode) as the effect sensing device.

A bifurcated fibre optic bundle 114 comprises a first fibre optic cable 116 for conducting electro-magnetic radiation from the electro-magnetic radiation emitter 110 to an output terminal 118 of the first fibre optic cable. The output terminal is arranged to illuminate a security document (when present) with electro-magnetic radiation from the electro-magnetic radiation emitter 110. The bifurcated fibre optic bundle also comprises a second fibre optic cable 120 which receives electro-magnetic radiation reflected from the security document, at an input end 122 of the second fibre optic cables. These second fibre optic cables serve to conduct the received electro-magnetic radiation to the electro-magnetic radiation detector 112 for measuring the intensity of the received electro-magnetic radiation. Electro-magnetic radiation detector 112 is arranged to communicate a measurement profile representative of the intensity of the electro-magnetic radiation received to the processor 104 for analysis and further processing. The first optical detection apparatus 108 thereby functions as a broadband (e.g. white) light interferometer. Electro-magnetic radiation is directed onto the multilayer polymer film substrate and electro-magnetic radiation which is reflected from the multilayer polymer film substrate is detected.

The apparatus 100 may be configured to receive a security document comprising opaque material printed on the majority of the surface of a transparent multilayer polymer film substrate, with at least one window through which electro-magnetic radiation can penetrate the substrate. A security document may be received in a slot or guide such that, when the security document is located in position, the optical detection apparatus 108 is arranged to direct electro-magnetic radiation onto a window which is transparent in the visible region of the electro-magnetic spectrum. The window may also additionally be transparent in the near-visible region of the electro-magnetic spectrum. The security document could be conducted past or through the apparatus 100 by way of a conveyor such that a transparent window of each successive security document passes the optical detection apparatus 108 in turn. Of course, the apparatus 100 could be moved relative to the security document in one or more embodiments.

In use, the electro-magnetic radiation detector 112 produces signals which are indicative of (e.g. proportional to, or proportional to the square of) the intensity of electro-magnetic radiation which is received by the electro-magnetic radiation detector 112 at a range of wavelengths. These signals are output by the electro-magnetic radiation detector as a sensed effect profile which, in one or more embodiments of the present invention comprises a sensed intensity profile.

In one or more other embodiments of the present invention, the electro-magnetic radiation detector 112 may be replaced, or supplemented, by another type of effect sensing device. In those one or more embodiments, the sensed effect profile may comprise signals which are indicative of some other measured parameter (or combination of two or more measured parameters).

The sensed effect profile (comprising a sensed intensity profile) from the electro-magnetic radiation detector 112 is transferred to the processor 104 which is arranged to carry out data processing, which is discussed further below, to derive a first data profile for the multilayer polymer film substrate of the security document being tested.

The processor 104 is arranged to assess whether or not the first data profile is that of a genuine multilayer polymer film substrate by comparing the first data profile to a second data profile representative of a specified effect profile. The second data profile is stored in memory 105 and the processor 104 is arranged to retrieve the second data profile from memory 105 to conduct the comparison. If the first data profile matches that of the specified effect profile of the second data profile, the processor is arranged to produce a positive authentication signal (e.g. a signal indicating that the security document being tested is genuine).

In terms of a “match” between the first data profile and the second data profile, the second data profile may include an error margin for data values within the second data profile. Thus, the first data profile may be considered to “match” the second data profile if data values within the first data profile fall within the error margin for corresponding data values of the second data profile.

The processor 104 may also be arranged to determine, from the first data profile, at least the following:
a depth of an interface between a surface of a first layer and a first surface of a second layer;
a depth of an interface between a second surface of the second layer and a surface of a third layer; and
a thickness of the second layer.

From this information, the depth of at least one reference layer may be determined and the thickness of such a reference layer (or layers) may also be determined.

The at least one reference layer of the multi-layer polymer film substrate effectively serves as a security layer. Thus, measurements of the multilayer polymer film substrate of an item being tested—particularly measurements relating to the at least one reference layer—are used by the apparatus 100 to determine whether or not the item is genuine. If, through measurement of the multilayer polymer film, it is determined that at least one layer has parameters which match specified parameters, then this is indicative that the multilayer polymer film substrate of the security document is genuine. This determination of whether or not a particular layer or layers has parameters and/or properties which match specified parameters and/or properties may not comprise a direct measurement of such parameters.

In the particular example described with reference to FIG. 1, determination is made based upon indirect measurements in which a film having layers comprising particular parameters and/or properties and a particular structure will give rise to a particular pattern and/or intensity of reflections of irradiating electro-magnetic radiation. A first data profile derived from an observed or measured effect (i.e. the particular pattern and/or intensity of reflections) is compared to a second data profile derived from the observed or measured effect of a genuine film substrate (or a specified second data profile which has been input to the apparatus 100).

A reference layer which may serve as a security layer may, for example, be of a specific thickness, and first and second surfaces of the reference layer may be within the multilayer polymer film substrate at specific distances from first and second surfaces of the multilayer polymer film substrate. Also, the reference layer may comprise, for example, a layer containing a taggant material, e.g. a material which absorbs a particular portion of the electro-magnetic spectrum. Also, a reference layer may comprise a layer of a specific thickness which is adjacent to another layer (reference or otherwise) containing a taggant material. These properties of the reference layer (or layers) and the location of the reference layer (or layers) may influence the effects observed/measured (e.g. the intensity of reflections received at a detector).

Authentication signals from the processor 104 are communicated to authenticity indication unit 106, which may be arranged to provide a visible and/or audible indication of the authentication signal to an operator of the apparatus 100.

In one or more embodiments of the present invention, the authenticity indication unit 106 further comprises a display arranged to display: the first data profile (i.e. a data profile comprising measurements relating to an item being tested); and/or the second data profile (e.g. a data profile of a designated genuine item); and/or an authentication decision (i.e. item being tested is genuine, or item being tested is counterfeit).

In one or more embodiments of the present invention, the display is further arranged to display data relating to the thickness of the reference layer and depth of first and second surfaces of the reference layer from first and second surfaces of the multilayer polymer film.

FIG. 2 schematically illustrates a particular arrangement and mode of operation of the apparatus 100 according to one or more embodiments of the present invention. For clarity purposes, some of the features illustrated in FIG. 1 are omitted in FIG. 2.

Emitter 110 is arranged to direct electro-magnetic radiation (denoted by line 124 in the figure) at a multilayer polymer film substrate 1020 which forms part of the security document.

The multilayer polymer film substrate 1020 comprises: a first layer 1021 (shown as the uppermost layer in FIG. 2); a second layer 1022; a third second layer 1023; and fourth layer 1024 (shown as the bottom layer in FIG. 2). A first surface (shown as the top surface in FIG. 2) of the multilayer polymer film substrate 1020 is denoted by reference 1025. A second surface (shown as the bottom surface in FIG. 2) is denoted by reference 1026.

A first surface of the first layer 1021 forms the first surface 1025 of the multilayer polymer film substrate 1020. The first surface 1025 forms an interface between a medium above the multilayer polymer film substrate 1020 (e.g. air) and the first layer 1021. Hereinafter, the first surface 1025 will be referred to as “first interface 1025”.

A second surface of the first layer 1021 is in contact with a first surface of the second layer 1022 and an interface formed where the first layer 1021 and second layer 1022 meet will be referred to hereinafter as “second interface 1027”. The second interface 1027 is at a distance d₁ from the first interface 1025.

A second surface of the second layer 1022 is in contact with a first surface of the third layer 1023 and an interface formed where the second layer 1022 and third layer 1023 meet will be referred to hereinafter as “third interface 1028”. The third interface 1028 is at a distance d₂ from the first interface 1025.

A second surface of the third layer 1023 is in contact with a first surface of the fourth layer 1024 and an interface formed where the third layer 1023 and fourth layer 1024 meet will be referred to hereinafter as “fourth interface 1029”. The fourth interface 1029 is at a distance d₃ from the first interface 1025.

A second surface of the fourth layer 1024 forms the second surface 1026 of the multilayer polymer film substrate 1020. The second surface 1026 forms an interface between a medium below the multilayer polymer film substrate 1020 and the fourth layer 1024. Hereinafter, the second surface 1026 will be referred to as “fifth interface 1026”. The fifth interface 1026 is at a distance d₄ from the first interface 1025. Distance d₄ is equivalent to the thickness of the multilayer polymer film substrate 1020.

Illuminating electro-magnetic radiation 124 emitted by the emitter 110 passes through the medium above the first interface 1025 until it reaches first interface 1025. Upon reaching first interface 1025, a portion of the incident electro-magnetic radiation 1024 is reflected from the first interface 1025 (denoted by line 124(r1)). A portion of the incident electro-magnetic radiation 124 is also transmitted through the first layer 1021 (denoted by line 124(t1)).

Transmitted electro-magnetic radiation 124(t1) in the first layer 1021 passes through the first layer 1021 until it reaches second interface 1027. Upon reaching the second interface 1027, a portion of the transmitted electro-magnetic radiation 124(t1) is reflected from the second interface 1027 (denoted by line 124(r2)). A portion of the transmitted electro-magnetic radiation 124(t1) is also transmitted through the second layer 1022 (denoted by line 124(t2)).

Similarly, transmitted electro-magnetic radiation 124(t2) in the second layer 1022 passes through the second layer 1022 until it reaches third interface 1028. Upon reaching the third interface 1028, a portion of the transmitted electro-magnetic radiation 124(t2) is reflected from the third interface 1028 (denoted by line 124(r3)). A portion of the transmitted electro-magnetic radiation 124(t2) is also transmitted through the third layer 1023 (denoted by line 124(t3)).

Similarly, transmitted electro-magnetic radiation 124(t3) in the third layer 1023 passes through the third layer 1023 until it reaches fourth interface 1029. Upon reaching the fourth interface 1029, a portion of the transmitted electro-magnetic radiation 124(t3) is reflected from the fourth interface 1029 (denoted by line 124(r4)). A portion of the transmitted electro-magnetic radiation 124(t3) is also transmitted through the fourth layer 1024 (denoted by line 124(t4)).

Finally, transmitted electro-magnetic radiation 124(t4) in the fourth layer 1024 passes through the fourth layer 1024 until it reaches fifth interface 1026. Upon reaching the fifth interface 1026, a portion of the transmitted electro-magnetic radiation 124(t4) is reflected from the fifth interface 1026 (denoted by line 124(r5)). A portion of the transmitted electro-magnetic radiation 124(t4) is also transmitted through the fifth interface 1026 (denoted by line 124(t5) into the medium below the multilayer polymer film substrate 1020.

In the particular illustrative example described here with reference to FIG. 2, the multilayer polymer film substrate 1020 is genuine. However, this fact may not be known to an operator using the apparatus 100 due to the fact that security features (e.g. one or more reference layers) of the multilayer polymer film substrate 1020 are covert and unlikely to be determinable with the naked eye.

In this particular example, the second layer 1022 is a reference layer of the multilayer polymer film substrate 1020 and comprises a taggant material which has a property of absorbing a range of wavelengths of the electro-magnetic spectrum. In this particular example, the taggant material serves to absorb those wavelengths of light which form a “green” part of the visible electro-magnetic spectrum (approximately 480 nm to 590 nm). The absorption taggant may serve as a “marker” to allow identification of genuine multilayer polymer film substrates using a process implemented by the apparatus 100. If the “marker” is present, an effect as sensed will match a specified effect (i.e. the first data profile derived from the sensed effect for the particular film being tested will match the second data profile). However, if no “marker” is present, for example, as in a counterfeit film substrate, the effect as sensed will not match the specified effect and thus the film can be identified by the apparatus 100 as one which is not genuine.

Thus, transmitted electro-magnetic radiation in the second layer 1022 (i.e. line 124(t2)), transmitted electro-magnetic radiation in the third layer 1023 (i.e. line 124(t3)), transmitted electro-magnetic radiation in the fourth layer 1024 (i.e. line 124(t4)), transmitted electro-magnetic radiation in the medium below the fifth interface 1026 (i.e. line 124(t5)), and reflections 124(r3), 124(r4) and 124(r5) comprise the remaining parts of the visible electro-magnetic spectrum (i.e. the white light spectrum minus those wavelengths giving rise to the “green” part of the spectrum).

The detector 112 is arranged to receive reflections of the illuminating electro-magnetic radiation 124 from each interface and output, to the processor 104, the sensed effect profile comprising the sensed intensity profile.

As described above, the processor 104 is arranged to carry out data processing to derive the first data profile for the multilayer polymer film substrate 1020.

A sensed effect profile comprising the sensed intensity profile is illustrated by way of example in FIG. 3a which illustrates the intensity of electro-magnetic radiation reflected from the multilayer polymer film substrate 102 having a structure as described above in relation to FIG. 2. Further, the multilayer polymer film substrate 102 is 100 μm thick and the four layers have thicknesses as follows:

first layer 1021—10 μm;

second layer 1022—20 μm;

third layer 1023—30 μm; and

fourth layer 1024—40 μm.

Also, and as described above, the second layer 1022 comprises a taggant material which has a property of absorbing those wavelengths of light which form a “green” part of the visible electro-magnetic spectrum.

For comparative purposes, FIG. 3b illustrates the intensity of electro-magnetic radiation reflected from a different multilayer polymer film substrate. This different multilayer polymer film substrate has the same structure as the multilayer polymer film substrate which gives rise to the sensed intensity profile illustrated in FIG. 3a, but does not include the taggant material in the second layer 1022.

From a comparison of the two graphs, it can be seen that the intensity of reflections in the green part of the visible electro-magnetic spectrum is attenuated in the sensed intensity profile illustrated in FIG. 3a. This is due to the presence of the taggant material in the second layer 1022 which serves to absorb a portion of the electro-magnetic radiation spectrum at wavelengths which correspond to the green part of the visible electro-magnetic spectrum.

In operation, the processor 104 receives a sensed intensity profile (such as those schematically illustrated in FIG. 3a or 3b) from the detector 112. The sensed intensity profile is indicative of the intensity of reflected electro-magnetic radiation at a range of different wavelengths. The measured data comprising the sensed intensity profile is processed by the processor to derive the first data profile. The first data profile is then compared to the second data profile by the processor and an authentication signal is provided based upon the comparison. The processor may also derive the thickness of the substrate and, if present, the thickness of one or more reference layers and/or groups of adjacent reference layers. These measurements are possible because electro-magnetic radiation which is reflected from two different interfaces, and which is sufficiently coherent (e.g. because it comes from the same source) will interfere. Where the source of electro-magnetic radiation and electro-magnetic radiation detector are fixed, the resulting interference means that the intensity varies with wavelength. The detected intensity can be described by the following simplified formula, where δ=2k₀nd cos θₜ:

I=I₁+I₂+2\sqrt{I₁I₂}cos δ

(θₜ is the angle of the incident rays after refraction at the first interface of the substrate which they encounter; d is the distance between two parallel interfaces from which electro-magnetic radiation is reflected; k₀ is the wave number of the incident electro-magnetic radiation (i.e. 2π divided by the wavelength), n is the refractive index of the first layer through which electro-magnetic radiation passes; I₁ and I₂ are the intensities of the electro-magnetic radiation reflected from the first and second interfaces which interfere to form a net measured intensity I).

The intensity of reflections from the multilayer polymer film substrate will vary cyclically with wavenumber (reciprocal of wavelength) and the distance between two interfaces, enabling the distance between two interfaces to be determined from the frequency of the cyclic variation in intensity of reflections with wavenumber. Where measurable interference is generated by reflection from a number of different pairs of interfaces, the measured intensity spectrum will include a corresponding number of different, superimposed, cyclically variable terms with different spatial frequencies. In order to determine the distance between each pair of interfaces which is generating measurable interference, a data set (i.e. a sensed intensity profile) comprising appropriately normalised relative reflection readings at a range of different wavenumbers is transformed into a frequency domain, for example, using a fast Fourier transform and appropriately scaled to produce a data set of power spectral density versus thickness. Peaks in the resulting data set indicate the distance between pairs of interfaces which are generating measurable interference in the measured substrate, and thus the thickness of layers, or groups of adjacent layers, in the measured substrate.

FIG. 4 schematically illustrates transformation function steps employed by the processor 104 using a fast Fourier transform to derive a first data profile (an example of which is illustrated in FIG. 5) from a sensed intensity profile (such as those as illustrated in FIGS. 3a and 3b). In FIG. 4, sub-figure (i) is a simplified illustration of a sensed intensity profile (i.e. such as those illustrated in FIGS. 3a and 3b) and sub-figure (v) is a simplified illustration of the derived first data profile (e.g. as illustrated in FIG. 5).

The Fourier transform relates the sensed intensity profile's time domain, shown in sub-figures (i) and (ii) of FIG. 4 (and in the left-hand portions of sub-figures (iii) and (iv), and in the top portion of sub-figure (vi) of FIG. 4) to the sensed intensity profile's frequency domain, shown in sub-figure (v) of FIG. 4 (and in the right-hand portion of sub-figure (iv) and the bottom portion of sub-figure (vi) of FIG. 4). Sub-figures (ii) and (iii) are simplified illustrations of the various reflections to show the sensed intensity profile itself and the component frequencies of the various reflections which form the sensed intensity profile as illustrated in sub-figure (i). These component frequencies, spread across the frequency spectrum, are represented as peaks in the frequency domain (i.e. the derived first data profile—see sub-figure (v), the right-hand portion of sub-figure (iv) and the bottom portion of sub-figure vi)).

FIG. 5 illustrates a resulting plot of power spectral density versus thickness (i.e. the derived first data profile) obtained by the processor 104 transforming the sensed intensity profile illustrated in FIG. 3b of the non-taggant multilayer polymer film substrate referred to above. Interference between electro-magnetic radiation reflected from each pair of two interfaces of the multilayer polymer film substrate will lead to an intensity peak at a location in the frequency domain which corresponds to the spacing between those interfaces. Where there are two pairs of interfaces which are separated by the same distance, the resulting intensity maximum in the frequency domain are superimposed, giving a combined peak.

The expected peaks, their expected relative strengths, and the layers whose combined thickness defines the spacing between those interfaces, may be specified in the second data profile which may form a characteristic of a genuine multilayer polymer film substrate with a given layer structure.

In FIG. 5, each peak is marked with an identifier of the form [n-m], where n and m are employed to denote a particular pair of interfaces which give rise to interference between electro-magnetic radiation reflected from that pair of interfaces. In this nomenclature, “n” is indicative of an upper interface of the pair and “m” a lower interface of the pair. Therefore, and with reference to FIG. 2 and the description relating thereto:
n=1, m=2, i.e. [1-2]—denotes the peak corresponding to interference between electro-magnetic radiation reflected from the first and second interfaces in the multilayer polymer film substrate (i.e. first interface 1025 and second interface 1027);
n=1, m=3, i.e. [1-3]—denotes the peak corresponding to interference between electro-magnetic radiation reflected from the first and third interfaces in the multilayer polymer film substrate (i.e. first interface 1025 and third interface 1028);
n=2, m=5, i.e. [2-5]—denotes the peak corresponding to interference between electro-magnetic radiation reflected from the second and fifth interfaces in the multilayer polymer film substrate (i.e. second interface 1027 and fifth interface 1026);
and so on.

In the non-taggant multilayer polymer film substrate (the sensed intensity profile of which is illustrated in FIG. 3b), the spacing between the pair of first and third interfaces and between the pair of third and fourth interfaces is the same, i.e. 30 μm). Thus, the peak with the identifier [1-3] & [3-4] is a combined peak in which the intensity maxima arising from each interface pair are superimposed.

When the processor 104 has derived the first data profile (an example of which is illustrated in FIG. 5) it is operative to assess whether a security document comprising the multilayer polymer film substrate which has been measured has specified characteristics (e.g. determining whether or not it comprises the reference layer at a specified position). After performing the assessment, the processor causes an authentication signal to be output, and an indication of this signal can be used to determine that the film substrate is genuine or otherwise by. In this example, the processor 104 takes into account the analysed intensity versus thickness data and determines whether peaks are present which indicate that the substrate of a security document has characteristic distances between reflecting surfaces, and therefore whether the thickness of the substrate as a whole, and layers within the substrate, have predetermined thicknesses. This is achieved by way of the processor 104 comparing the first data profile with the second data profile (e.g. a profile representative of a genuine multilayer polymer film substrate). Thus, if the first and second data profile match (i.e. peaks in the first data profile match all peaks in the second data profile), the processor 104 is arranged to determine that the multilayer polymer film substrate being tested is genuine and cause a positive authentic signal to be output.

While the above described authentication process may be suitable in a system which is arranged to check the overall thickness of a multilayer polymer film substrate and the thickness of layers therein, it may not be suitable where a determination of a layer's position within a stack of layers is required.

Thus, in a system arranged to determine the position of one or more reference layers within a body of a multilayer polymer film substrate (i.e. the distance between a surface of the reference layer (or layers) and some reference point), the processor 104 would need to implement further determination steps.

These further determination steps are described below in relation to FIGS. 6a to 6c and with particular reference to the example multilayer polymer film substrates described above which give rise to sensed intensity profiles as illustrated in FIGS. 3a and 3b.

It will be recalled that the both multilayer polymer film substrates have the same structure, i.e. a first layer 1021 of thickness 10 μm, a second layer 1022 of thickness 20 μm, a third layer of thickness 30 μm, and a fourth layer of thickness 40 μm. The two multilayer polymer film substrates differ in that the second layer 1022 of one contains a taggant material which serves to absorb those wavelengths of light which form a “green” part of the visible electro-magnetic spectrum (approximately 480 nm to 590 nm), whereas the other one (i.e. the non-taggant film substrate) has no such taggant material.

For the purposes of this explanation, the multilayer polymer film substrate with the taggant material is considered to be a genuine multilayer polymer film substrate and the non-taggant film substrate is considered to be an example of a counterfeit multilayer polymer film substrate.

In order to determine whether or not a reference layer is present and to determine the thickness and depth of the reference layer (i.e. the second layer 1022 in the present example), the processor is arranged to mask the first data profile of the film substrate being tested. Since the apparatus 100 is configured, in this example, to provide a positive authentication decision for film substrates having a green-light absorbing taggant material, the processor 104 is arranged to mask the first data profile to eliminate those peaks which arise from interfering reflections comprising light in the non-green parts of the visible electro-magnetic spectrum (e.g. outside the range 480 nm to 590 nm).

FIG. 6a illustrates a modified specified data profile which is obtained by applying a mask function to an original specified data profile, e.g. a second data profile modified using the masking function referred to above. Optionally, the specified data profile comprising the second data profile, may include both a data profile for all wavelengths of irradiating electro-magnetic radiation and a different data profile specific to, for example, the green part the visible electro-magnetic spectrum. In such an optional arrangement, and for a film substrate being tested to be deemed genuine, the unmasked first data profile must match the “all wavelengths” data profile of the second data profile and the masked first data profile must match the “green wavelengths” specific data profile of the second data profile.

FIG. 6b illustrates a modified first data profile for the non-taggant multilayer polymer film substrate (a non-genuine film substrate in the present example) where the modified data profile is obtained by applying the mask function to the first data profile illustrated in FIG. 5. Since this non-taggant film substrate does not contain the green-light absorbing material, all interfaces of the film substrate will reflect electro-magnetic radiation at all wavelengths.

FIG. 6c illustrates a modified first data profile for a genuine multilayer polymer film (e.g. the taggant-containing film substrate of the present example). The modified first data profile is obtained by applying the mask function to the first data profile derived from the sensed intensity profile.

As can be seen from comparing FIGS. 6a and 6b, i.e. specified profile versus first data profile of the non-genuine film substrate being tested, the profiles of the plots do not match. Through a same comparison of FIGS. 6a and 6c, i.e. specified profile versus first data profile of the genuine film substrate being tested, it can be seen that the profiles of the plots match. It is a comparison of this nature which the processor 104 is arranged to conduct to establish if a film substrate is genuine or otherwise. The processor 104, from the modified first data profile can also determine a distance between a surface of the film at the side being illuminated and a surface of the taggant-containing reference layer closest to that film surface. This distance value provides an indication of the depth of one surface of the taggant-containing reference layer from surface of the film at the side being illuminated.

In an optional arrangement, a colour filter may be located in front of the detector 112 to achieve the same effect as the masking function implemented by the processor 104.

FIG. 7 schematically illustrates another particular arrangement and mode of operation of the apparatus 100 according to one or more embodiments of the present invention. For clarity purposes, some of the features illustrated in FIG. 1 are omitted in FIG. 7 (e.g. memory, processor and authenticity indication unit). Features which are common to those illustrated in FIGS. 1 and 2 are denoted using like reference numbers.

Emitter 110 is arranged to direct two beams of electro-magnetic radiation (denoted by lines 126 and 128 in the figure) at the multilayer polymer film substrate 1020 which forms part of the security document. First illuminating beam 126 is emitted from the emitter 110 at a first angle α and second illuminating beam 128 is emitted from the emitter 110 at a second angle β. The emitter 110 is arranged to direct the illuminating beams 126, 128 at the multilayer polymer film substrate 1020 in a consecutive manner, i.e. not at the same time.

In this figure, reflections from the first interface 1025 and the fifth interface 1026 are omitted for clarity purposes.

Reflections of the first illuminating beam 126 are denoted by the reference numeral 126(rₙ₋₁), where n is the interface number. Thus, a reflection of first illuminating beam 126 from the second interface 1027 is denoted by reference 126(r1), a reflection of first illuminating beam 126 from the third interface 1028 is denoted by reference 126(r2), and a reflection of first illuminating beam 126 from the fourth interface 1029 is denoted by reference 126(r3). Similarly, a reflection of second illuminating beam 128 from the second interface 1027 is denoted by reference 128(r1), a reflection of second illuminating beam 128 from the third interface 1028 is denoted by reference 128(r2), and a reflection of second illuminating beam 128 from the fourth interface 1029 is denoted by reference 128(r3).

In this particular arrangement, the detector 112 comprises an array of sub-detectors.

In operation, first and second illuminating electro-magnetic radiation beams 126, 128 emitted by the emitter 110 pass through the medium above the first interface 1025 until they reach first interface 1025. Upon reaching first interface 1025, a portion of each of the incident first and second illuminating electro-magnetic radiation beams 126, 128 is reflected from the first interface 1025 (not shown). A portion of each of the incident first and second illuminating electro-magnetic radiation beams 126, 128 is also transmitted through the first layer 1021.

Transmitted electro-magnetic radiation of both the first and second beams 126, 128 in the first layer 1021 passes through the first layer 1021 until it reaches second interface 1027. Upon reaching the second interface 1027, a portion of each of the first and second beams 126, 128 is reflected from the second interface 1027 (denoted by lines 126(r1) and 128(r1) respectively). A portion of the each of the first and second beams 126, 128 is also transmitted through the second layer.

Similarly, transmitted electro-magnetic radiation of both the first and second beams 126, 128 in the second layer 1022 passes through the second layer 1022 until it reaches third interface 1028. Upon reaching the third interface 1028, a portion of each of the first and second beams 126, 128 is reflected from the third interface 1028 (denoted by lines 126(r2) and 128(r2) respectively). A portion of each of the first and second beams 126, 128 is also transmitted through the third layer 1023.

Similarly, transmitted electro-magnetic radiation of both the first and second beams 126, 128 in the third layer 1023 passes through the third layer 1023 until it reaches fourth interface 1029. Upon reaching the fourth interface 1029, a portion of each of the first and second beams 126, 128 is reflected from the fourth interface 1029 (denoted by lines 126(r3) and 128(r3) respectively).

A portion of each of the first and second beams 126, 128 is also transmitted through the fourth layer 1024 until it reaches fifth interface 1026. Upon reaching the fifth interface 1026, a portion of each of the first and second beams 126, is reflected from the fifth interface 1026 (not shown). A portion of each of the first and second beams 126, 128 is also transmitted through the fifth interface 1026 (not shown) into the medium below the multilayer polymer film substrate 1020.

In the particular illustrative example described here with reference to FIG. 7, the multilayer polymer film substrate 1020 is genuine. However, this fact may not be known to an operator using the apparatus 100 due to the fact that security features (e.g. one or more reference layers) of the multilayer polymer film substrate 1020 are covert and unlikely to be determinable with the naked eye.

In the illustrated example, reflected beam 126(r1) of the first beam 126 is received at a ninth sub-detector 112a of the detector 112. Similarly, a reflected beam 126(r2) of the first beam 126 is received at a fourteenth sub-detector 112b of the detector 112, and a reflected beam 126(r3) of the first beam 126 is received at a nineteenth sub-detector 112c of the detector 112. Reflected beam 128(r1) of the second beam 128 is received at a fourth sub-detector 112d of the detector 112. Similarly, a reflected beam 128(r2) of the second beam 128 is received at a seventh sub-detector 112b of the detector 112, and a reflected beam 128(r3) of the second beam 128 is received at a tenth sub-detector 112c of the detector 112.

The sensed effect profile (comprising a positional intensity profile) from the electro-magnetic radiation detector 112 is communicated to the processor which is arranged to derive a first data profile for the multilayer polymer film substrate 1020 of the security document being tested. In deriving such a first data profile, the processor determines which sub-detectors of the detector array have detected incident radiation (i.e. from reflections) at an intensity above a specific threshold. Thus, in the present example the processor 104 is arranged to derive a first data profile from the positional intensity profile output by the detector and this first data profile can be summarised by way of Table 1 below.

TABLE 1

| REFLECTED BEAM | SUB-DETECTOR |
|---|---|
| 126(r1) | Ninth (112a) |
| 128(r1) | Fourth(112d) |
| 126(r2) | Fourteenth (112b) |
| 128(r2) | Seventh (112e) |
| 126(r3) | Nineteenth (112c) |
| 128(r3) | Tenth (112f) |

The first data profile as summarised above is then compared to the second data profile by the processor and an authentication signal is provided based upon the comparison.

The second data profile may have been obtained initially by testing a known genuine multilayer polymer film substrate using the apparatus 100 of FIG. 7 and recording the sub-detectors at which reflected beams of electro-magnetic radiation were received. This second data profile compilation process could, for example, be performed as part of a calibration process of the apparatus 100. The second data profile obtained may then be stored in memory and be referred to during testing of other multilayer polymer film substrates.

The processor may be further operative to determine the depth of each interface, i.e. 1027, 1028, 1029, based upon known (e.g. stored) spacings between each of the sub-detectors of the array and a reference point, and known angles at which the first and second illuminating beams 126, 128 are emitted from emitter 110. From these known values, and the sub-detectors at which reflections are received, the processor can operate to calculate the depth of each interface.

In a particular example, the apparatus 100 may be arranged to authenticate by detection for a film substrate in which a highly reflective taggant material is located in a reference layer of the multilayer polymer film substrate 1020. The taggant material may comprise a suitable reflective pigment additive and an assessment of reflectivity could be made based upon the colour of the reflected light. In this particular example, the highly-reflective taggant material may serve to reflect a substantial portion of the first and second illuminating beams 126, 128. Since a substantial portion of the illuminating beams 126, 128 is reflected by the reference layer containing the reflective taggant material, very little of the illuminating beams 126, 128 will be transmitted to layers beneath the taggant-containing reference layer. As such, there may be only weak reflections or no reflections from interfaces between layers beneath the reference layer. In such an example, the processor may be configured to set the intensity threshold at a relatively high level so that weak reflections from interfaces between layers beneath the reference layer are not deemed to be “valid” detections because they are of an intensity below the threshold. Similarly, reflections from interfaces between layers above the reference layer may also be of a level which is below the threshold level. Accordingly, only reflections from the interface between the reference layer and an adjacent layer will be of sufficient intensity to be deemed “valid”. The processor 104 therefore can effectively ignore reflections from any interface apart from one associated with the reference layer. Based upon this, the processor can determine the depth of such an interface based upon the spacing between the sub-detectors which receive reflections from the first and second illuminating beams 126, 128. In such a mode of operation, the two illuminating beams 126, 128 may be emitted simultaneously.

As with the absorption taggant described previously, the highly reflective taggant may serve as a “marker” to allow identification of genuine multilayer polymer film substrates using a process implemented by the apparatus 100 illustrated in FIG. 7. If the “marker” is present, an effect as sensed will match a specified effect (i.e. the first data profile derived from the sensed effect for the particular film being tested will match the second data profile). However, if no “marker” is present, for example, as in a counterfeit film substrate, the effect as sensed will not match the specified effect and thus the film can be identified by the apparatus 100 as one which is not genuine.

FIG. 8 schematically illustrates another particular arrangement and mode of operation of the apparatus 100 according to one or more embodiments of the present invention. For clarity purposes, some of the features illustrated in FIG. 1 are omitted in FIG. 8 (e.g. memory, processor and authenticity indication unit). Features which are common to those illustrated in FIG. 2 are denoted using like reference numbers.

Emitter 110 is arranged to direct, at an angle θ, a single beam of electro-magnetic radiation (denoted by line 130) at the multilayer polymer film substrate 1020 which forms part of the security document.

Reflections of the illuminating beam 130 are denoted by the reference numeral 130(rₙ), where n is the interface number. Thus, a reflection of the illuminating beam 130 from the first interface 1025 is denoted by reference 130(r1), a reflection of the illuminating beam 130 from the second interface 1027 is denoted by reference 130(r2), and so on.

As for the particular arrangement illustrated in FIG. 7, this particular arrangement as illustrated in FIG. 8 also comprises a detector 112 that comprises an array of sub-detectors.

In operation, illuminating electro-magnetic radiation beam 130 emitted by the emitter 110 passes through the medium above the first interface 1025 until it reaches first interface 1025. Upon reaching first interface 1025, a portion of the incident illuminating electro-magnetic radiation beam 130 is reflected from the first interface 1025 (denoted by line 130(r1)). A portion of the incident illuminating electro-magnetic radiation beam 130 is also transmitted through the first layer 1021.

Transmitted electro-magnetic radiation of the illuminating beam 130 in the first layer 1021 passes through the first layer 1021 until it reaches second interface 1027. Upon reaching the second interface 1027, a portion of the illuminating beam 130 is reflected from the second interface 1027 (denoted by line 130(r2)). A portion of the illuminating beam 130 is also transmitted through the second layer 1022.

Similarly, transmitted electro-magnetic radiation of the illuminating beam 130 in the second layer 1022 passes through the second layer 1022 until it reaches third interface 1028. Upon reaching the third interface 1028, a portion of the illuminating beam 130 is reflected from the third interface 1028 (denoted by line 130(r3)). A portion of the illuminating beam 130 is also transmitted through the third layer 1023.

Similarly, transmitted electro-magnetic radiation of the illuminating beam 130 in the third layer 1023 passes through the third layer 1023 until it reaches fourth interface 1029. Upon reaching the fourth interface 1029, a portion of the illuminating beam 130 is reflected from the fourth interface 1029 (denoted by line 130(r4)).

A portion of the illuminating beam 130 is also transmitted through the fourth layer 1024 until it reaches fifth interface 1026. Upon reaching the fifth interface 1026, a portion of the illuminating beam 130 is reflected from the fifth interface 1026 (not shown). A portion of each of the first and second beams 126, 128 is also transmitted through the fifth interface 1026 (not shown) into the medium below the multilayer polymer film substrate 1020.

In the particular illustrative example described here with reference to FIG. 8, the multilayer polymer film substrate 1020 is genuine. However, this fact is unlikely to be known to an operator using the apparatus 100 due to the fact that security features (e.g. one or more reference layers) of the multilayer polymer film substrate 1020 are covert and unlikely to be determinable with the naked eye.

In the illustrated example, reflected beam 130(r1) of the illuminating beam 130 is received at a first sub-detector 112(1) of the detector 112. Similarly, a reflected beam 130(r2) of the illuminating beam 130 is received at a second sub-detector 112(2) of the detector, and so on.

The sensed effect profile (comprising a positional intensity profile) from the electro-magnetic radiation detector 112 is transferred to the processor which is arranged to derive a first data profile for the multilayer polymer film substrate 1020 of the security document being tested. In deriving such a first data profile, the processor determines which sub-detectors of the detector array have detected incident radiation (i.e. from reflections) at an intensity above a specific threshold. Thus, in the present example the processor 104 is arranged to derive a first data profile from the positional intensity profile output by the detector 112.

The first data profile as summarised in the paragraph above is then compared to the second data profile by the processor and an authentication signal is provided based upon the comparison.

As with the other arrangements described above, the second data profile may have been obtained initially by testing a known genuine multilayer polymer film substrate using the apparatus 100 of FIG. 8 and recording the sub-detectors at which reflected beams of electro-magnetic radiation were received. This second data profile compilation process could, for example, be performed as part of a calibration process of the apparatus 100. The second data profile obtained may then be stored in memory and be referred to during testing of other multilayer polymer film substrates.

The processor may be further arranged to determine the depth of each interface, e.g. 1027, 1028, 1029, based upon known (e.g. stored) spacings between each of the sub-detectors of the array and a reference point, and known angles at which the illuminating beam is emitted from the emitter 110. From these known values, and the sub-detectors at which reflections are received, the processor can operate to calculate the depth of each interface.

In FIG. 8, interface depths are calculated based upon the horizontal spacing between sub-detectors and a reference point on the emitter. A first spacing between the reference point and a first sub-detector is denoted by reference h₁. A second spacing between the reference point and a second sub-detector is denoted by reference h₂. An nth spacing between the reference point and nth sub-detector is denoted by reference hₙ. The horizontal spacing between sub-detectors is denoted by Δₙₘ (where Δₘₙ=hₘ−hₙ and where m>n). Thus, the horizontal spacing between, for example, the second sub-detector 112(2) and the first sub-detector 112(1) is Δ₂₁, i.e. h₂−h₁. Depth values can be calculated as follows:

d1=Δ₂₁ tan(90−θ);

d2=Δ₃₁ tan(90−θ);

d3=Δ₄₁ tan(90−θ); and

d4=Δ₅₁ tan(90−θ).

FIG. 9 schematically illustrates another particular arrangement and mode of operation of the apparatus 100 according to one or more embodiments of the present invention. Features which are common to those illustrated in figures referred to above are denoted using like reference numbers.

In this particular arrangement, the apparatus 100 is arranged to employ a confocal microscopy technique to determine the authenticity of a multilayer polymer film substrate being tested. In this regard, the apparatus 100 further comprises a first plate 132 formed with an aperture. The first plate 132 is located adjacent the emitter 110 in a position such that an illuminating electro-magnetic radiation beam 134 (denoted by the dashed line) emitted by emitter 110 can pass through the aperture.

The apparatus 100 also comprises a beam splitter 136 and focusing optics 138 positioned between the plate 132 and a region of the apparatus 100 where the multilayer polymer film substrate being tested can be located. Both the beam splitter 136 and focusing optics 138 are located in a path of the illuminating electro-magnetic radiation beam 134.

In operation therefore, illuminating electro-magnetic radiation beam 134 from the emitter 110 passes through the aperture in the plate 132, the beam splitter 136 and is focussed by the focussing optics 138 onto the multilayer polymer film substrate being tested. The focussing optics 138 serve to focus the illuminating electro-magnetic radiation beam 134 to a point in a focal plane 140 at depth d_{z}. In the figure, the focal plane 140 is at depth d₃.

The depth d_{z} of the focal plane 140 can be altered by moving the focusing optics 138 toward or away from the multilayer polymer film substrate 1020 being tested (denoted by arrow A in the figure). Such movement is effected by an actuator 142, the operation of which is controlled by processor 104.

The part of the multilayer polymer film substrate 1020 being tested which is at the focal point in the focal plane 140 receives the illuminating electro-magnetic radiation beam 134. This part of the multilayer polymer film substrate 1020 is excited through stimulation by the illuminating electro-magnetic radiation beam 134. The resulting fluorescence causes a reflected electro-magnetic radiation beam to be focused through the focusing optics 138 in a direction opposite to the illuminating electro-magnetic radiation beam 134. Upon reaching the beam splitter 136, the reflected electro-magnetic radiation beam is redirected by the beam splitter 136 toward a second plate 144 located adjacent detector 112. The second plate 144 is formed with an aperture though which an in-focus reflected electro-magnetic radiation beam can pass on route to the detector 112.

The aperture in second plate 144 serves to limit the electro-magnetic radiation that can reach the detector 110 to that which originates in the focal plane 140 of the lens (i.e. in-focus reflections). The aperture in second plate 144 thus serves to eliminate out-of-focus reflections. This effect is illustrated in the figure, where an out-of-focus reflected electro-magnetic radiation beam is denoted by reference 146 and an in-focus reflected electro-magnetic radiation beam is denoted by reference 148. It can be seen that the out-of-focus reflected electro-magnetic radiation beam 146 is blocked by the second plate 144 whereas the in-focus reflected electro-magnetic radiation beam 148 can pass through the aperture in the second plate 144 and reach the detector 110.

The processor 104 is arranged to determine the depth of the fluorescence based upon a sensed intensity profile received from the detector 110. In particular, the sensed intensity profile comprises intensity data for in-focus reflected electro-magnetic radiation beams over a range of focal point positions (e.g. d₀, d₁, d₂, d₃, d₄, d₅, dₙ as illustrated in the figure). Thus, in the present example the processor 104 is arranged to derive a first data profile from the sensed intensity profile output by the detector and this first data profile can be summarised by way of Table 2 below.

TABLE 2

| Focal plane depth | Measured intensity value |
|---|---|
| d₀ | 1^{st} intensity value |
| d₁ | 2^{nd} intensity value |
| d₂ | 3^{rd} intensity value |
| d₃ | 4^{th} intensity value |
| d₄ | 5^{th} intensity value |
| d₅ | 6^{th} intensity value |
| dₙ | n^{th} intensity value |

This particular arrangement may be suitable for detecting for multilayer polymer film substrates in which a reference layer comprises a fluorescent taggant material. Such a taggant material may be considered to be passive in that it is caused to fluoresce only when stimulated (i.e. it is stimulable and may be stimulated by the illuminating electro-magnetic radiation beam being 134 being incident thereon).

Again, in the particular illustrative example described here with reference to FIG. 9, the multilayer polymer film substrate 1020 is genuine. However, and as described previously, this fact may not be known to an operator using the apparatus 100 due to the fact that security features (e.g. one or more reference layers) of the multilayer polymer film substrate 1020 are covert and unlikely to be determinable with the naked eye.

In this particular example, the second layer 1022 is a reference layer of the multilayer polymer film substrate 1020 and comprises a fluorescent taggant material such as that described above. The fluorescent taggant may serve as a “marker” to allow identification of genuine multilayer polymer film substrates using a process implemented by the apparatus 100. If the “marker” is present, an effect as sensed will match a specified effect (i.e. the first data profile derived from the sensed effect for the particular film being tested will match the second data profile). However, if no “marker” is present, for example, as in a counterfeit film substrate, the effect as sensed will not match the specified effect at thus the film can be identified by the apparatus 100 as one which is not genuine.

Thus, in an apparatus 100 arranged to verify if a multilayer polymer film substrate being tested is of this type, the processor 104 is arranged to control the actuator 142 to change the position of the focusing optics 138. This allows the multilayer polymer film substrate 1020 to be scanned through its depth because the movement of the focusing optics 138 changes the position of the focal point.

Initially, the position of the focal point may be controlled by the processor 104 so that scanning begins at a point above a top surface, or below a bottom surface, of the multilayer polymer film substrate 1020. The processor 104 operates to control the position of the focal point and move the focal plane down or up through the multilayer polymer film substrate 1020. A sensed intensity profile output by the detector 112 contains intensity readings for a number of different focal point positions.

A first data profile as derived by processor 104 from the sensed intensity profile received from detector 112 is schematically illustrated in FIG. 10. As can be seen, the intensity of the reflection received by the detector 110 increases from a background level when the focal point passes through the first interface 1025 (i.e. at depth d₀). This is due to the focal point moving from a position above the film substrate 1020 to a position at the surface of the first layer 1021. The increase in intensity is due to fluorescence of the material of the first layer 1021.

As scanning continues and the focal point continues to move through the first layer 1021 to a position within the first layer 1021 at depth d₁, the intensity of the reflection received by the detector remains substantially the same as that at depth d₀. However, as scanning continues further and the focal point moves to a position (d₂) coincident with second interface 1027, the illuminating electro-magnetic radiation beam 134 is focussed upon the second layer 1022 containing the fluorescent taggant material. That is, a greater intensity of the energy of the illuminating electro-magnetic radiation beam 134 is focussed on the fluorescent taggant material in the second layer 1022. The illuminating electro-magnetic radiation beam 134 serves to stimulate the fluorescent taggant material thus causing it to fluoresce and the intensity of radiation received by the detector 110 will increase as a result of this fluorescence. This effect is shown by the sharp increase in intensity as illustrated in FIG. 10.

As scanning continues and the focal point continues to move through the second layer 1022 to a position within the second layer 1022 at depth d₃, the intensity of the reflection received by the detector remains substantially the same as that at depth d₂. This effect is shown by the plateau region of the intensity versus focal point position curve as illustrated in FIG. 10.

The intensity of the received beam at the detector 112 remains at this relatively high level until the focal point moves to a position (d₄) coincident with third interface 1028. As the focal point moves past this position, it moves into the third layer 1023. Since the focal point has now moved into a layer which does not contain a fluorescent taggant material, the level of fluorescence will diminish and thus the intensity of the electro-magnetic radiation beam received at the detector 112 will also decrease. This effect is shown by the sharp decrease from the plateau region to a relatively low level of the intensity versus focal point position curve as illustrated in FIG. 10.

The intensity of the received beam at the detector 112 remains at this relatively low level as the focal point moves through the third layer 1023 (position d₅) and decreases yet further as the focal point passes through fourth interface 1029 into material of the fourth layer 1024.

Finally, the intensity of the received beam at the detector 112 decreases to the background level when the focal point passes through the fifth interface 1026 (i.e. at depth dₙ). This is due to the focal point moving from a position within the film substrate 1020 to a position below a bottom surface of the film substrate 1020.

In determining whether or not a multilayer polymer film substrate being tested is genuine, the processor 104 is arranged to compare the first data profile (such as that illustrated graphically in FIG. 10) to the second data profile. If the profiles match, the processor 104 is arranged to output a positive authentication signal and the film is deemed to be genuine.

The processor 104 may also operate to determine a depth of the reference layer from surfaces of the multilayer polymer film substrate and a thickness of the reference layer. This may be achieved by the processor 104 monitoring intensity data from the detector 112 and noting focal point positions at which the intensity increases above and decreases below a specified threshold intensity level (Iₜₕ—see FIG. 10). This can be used to determine that the focal point position has moved into/from a region of high fluorescence and thus provides an indication that the focal point position is passing into or through a layer containing a fluorescent material and from a layer containing a fluorescent material into another layer. Such a determination by the processor 104 leads to a determination that the focal point position coincident with the increase to a level above the threshold intensity Iₜₕ and the focal point position coincident with the decrease to a level below the threshold intensity Iₜₕ denote the scanning beam passing through first and second surfaces of the reference layer. The depth of the reference layer from the film substrate surface and its thickness can be calculated by the processor 104 based upon the noted focal point positions at which these effects occur.

FIG. 11 schematically illustrates another particular arrangement and mode of operation of the apparatus 100 according to one or more embodiments of the present invention. Features which are common to those illustrated in other figures are denoted using like reference numbers.

In this particular arrangement, the apparatus 100 is arranged to employ a confocal measurement technique to determine the authenticity of a multilayer polymer film substrate being tested. The technique is similar to that described above in relation to FIG. 9.

The technique makes use of a lens error commonly known as chromatic aberration. Chromatic aberration (also called achromatism or chromatic distortion) is a type of distortion in which there is a failure of a lens to focus all colours to the same convergence point. It occurs because lenses have a different refractive index for different wavelengths of light (the dispersion of the lens). Thus, the axial position of the focal point of an uncorrected lens depends on the colour (wavelength) of the light to be focussed. In the visible region of the electro-magnetic spectrum, the focal distance for shorter wavelength light (e.g. blue light) is minimal. However, it is a maximum for longer wavelength light (e.g. red light). The focal points of wavelengths between these wavelength extremes (i.e. other colours of light) fall between the maximum and minimum.

If a plot of the intensity of reflections received by the detector 112 versus wavelength is created from the reflected electro-magnetic radiation received at the detector 112, such a plot could be represented schematically as in FIG. 12a. Reflections from around a depth d₁ in the multilayer polymer film substrate 1020 would comprise electro-magnetic radiation of wavelength λₘᵢₙ (i.e. a blue portion of the visible electro-magnetic spectrum). Reflections from around a depth d₃ in the multilayer polymer film substrate 1020 would comprise electro-magnetic radiation of wavelength λ₁ (i.e. a green portion of the visible electro-magnetic spectrum). Reflections from around a depth d₅ in the multilayer polymer film substrate 1020 would comprise electro-magnetic radiation of wavelength λₘₐₓ (i.e. a red portion of the visible electro-magnetic spectrum).

For the purposes of explaining how the processor 104 derives the first data profile from the sensed intensity profile (i.e. as illustrated in FIG. 12a), the multilayer polymer film substrate 1020 of FIG. 11 is considered to be a genuine multilayer polymer film substrate. Second layer 1022 of thickness, t, comprises the reference layer. Second layer 1022 has interfaces at depths d₂ and d₄ from a reference position.

In order to determine whether or not the reference layer is: (i) present; and (ii) at a correct depth, the processor 104 is arranged to mask a portion of the sensed intensity profile of multilayer polymer film substrate 1020 to derive the first data profile. The mask serves to exclude reflections at those wavelengths which would be reflected by portions of the film substrate 1020 at depths less than d₂ and greater than d₄. This is because the reference layer is expected to be at a position between depths d₂ and d₄.

The first data profile is illustrated schematically in FIG. 12b. It can be seen that, for the depths of interest, i.e. between d₂ and d₄ there is an intensity peak which is at a maximum intensity at a depth d₃ corresponding to reflected light of wavelength

The processor 104 can determine whether or not a multilayer polymer film substrate being tested is genuine by comparing the first data profile (such as that illustrated graphically in FIG. 12b) to the second data profile. If the profiles match (i.e. if the position and shape of an intensity peak in the first data profile matches the position and shape of an intensity peak in the second data profile), the processor 104 is arranged to output a positive authentication signal and the film is deemed to be genuine.

The processor 104 may also operate to determine a depth of the reference layer from a reference point and a thickness, t, of the reference layer. This may be achieved by the processor 104 noting the wavelength values in the first data profile which coincide with the start and end points of the intensity peak. With reference to a look-up table, the processor 104 can determine the distance from a reference point for reflections at those particular wavelengths. Once those distances are known, the positions of the top and bottom surfaces of the reference layer can be calculated and, from positional data for each surface, the thickness can be calculated from the difference between the positional data of each surface.

FIG. 13 schematically illustrates another particular arrangement and mode of operation of the apparatus 100 according to one or more embodiments of the present invention. Features which are common to those illustrated in other figures are denoted using like reference numbers.

In this particular arrangement, the apparatus 100 is arranged to employ an attenuation measurement technique.

Attenuation measurement techniques operate via the principle of using either the interaction of a material with an added energy source or self-generating the energy from the material, and then using the measured signal strength to assess how much energy has been attenuated and therefore what the path length through the material the energy has been subjected to.

The apparatus 100 according to this particular arrangement may be suitable for detecting for multilayer polymer film substrates in which a reference layer comprises an active or passive taggant material. An active taggant material may comprise a material which serves as a spontaneous emission source of energy carrying particles and/or waves. A passive taggant material (e.g. a stimulable taggant material) may comprise a material which serves as an emission source of energy carrying particles and/or waves, with such particles being emitted when the emission source is stimulated by an external energy source.

The following description assumes that an emission source material (spontaneous or otherwise) is provided as a taggant material in the second layer 1022 of the multilayer polymer film substrate 1020. Thus, the second layer 1022 is the reference layer.

The emitter 110 is arranged to emit a reference beam 150 of electro-magnetic radiation toward the detector 112. Emitter 110 is also arranged to emit a transmission beam 152 of electro-magnetic radiation through the multilayer polymer film substrate 1020 for detection by the detector 112 and a stimulating beam 154 of electro-magnetic radiation into the body of the multilayer polymer film substrate 1020.

Stimulating beam 154 serves to stimulate any passive taggant material and cause the passive taggant material to emit energy carrying particles and/or waves. Energy carrying particles and/or waves caused to be emitted by the stimulating effect of the stimulating beam 154 are denoted by undulating lines 156.

Energy carrying particles and/or waves arising from spontaneous emission from an active taggant material which might be located in the reference layer are denoted by undulating lines 158.

The attenuation technique employed by the apparatus 100 makes use of the Beer-Lambert law or some other parallel law that is applicable to the relevant energy source. The general form of such a law is:

I=Iₒe^{-βz}

Where Iₒ is the original energy intensity, z is the path length through the material and β is an absorption coefficient.

The original (i.e. unattenuated) intensity of energy carrying particles and/or waves emitted by an active or passive taggant material located in the reference layer (i.e. second layer 1022 in the illustrated example) have intensity I₁.

Those energy carrying particles and/or waves transmitted from the second layer 1022 through the first surface of the multilayer polymer film substrate 1020 toward a portion of the detector 110 above the multilayer polymer film substrate 1020 have intensity I₂. In the present case, energy carrying particles and/or waves emitted by stimulation and spontaneously are considered to have the same intensity.

Those energy carrying particles and/or waves transmitted from the second layer 1022 through the second surface of the multilayer polymer film substrate 1020 toward a portion of the detector 110 below the multilayer polymer film substrate 1020 have intensity I₃. Again, energy carrying particles and/or waves emitted by stimulation and spontaneously are considered to have the same intensity.

The original (i.e. unattenuated) intensity of reference beam 150 upon emission from emitter 110 has intensity I₆ and the intensity upon receipt at the detector 112 is I₇.

The original (i.e. unattenuated) intensity of transmission beam 152 upon emission from emitter 110 has intensity I₄ and the intensity upon receipt at the detector 112 is I₅.

The thickness of film substrate material above the second layer 1022 is denoted by reference z₁, the thickness of film substrate material below the second layer 1022 is denoted by reference z₂, the thickness of multilayer polymer film substrate 1020 is denoted by reference z₃, and the thickness of the second (reference) layer 1022 is denoted by t.

From the equation expressing the Beer-Lambert law noted above, the following can be derived:

I₂=I₁e^{-βz1}

I₃=I₁e^{-βz2}

I₅=I₄e^{-βz3}

It is assumed that I₇=I₆ because the attenuation of reference beam 150 during transmission through the medium between emitter 110 and detector 112 (e.g. air) is negligible over the distance involved. Also, because reference beam 150 and transmission beam 152 are emitted from the same source, i.e. emitter 110, they are assumed to be equal. Thus, I₄=I₆=I₇.

The processor 104 receives from the detector 112 a sensed intensity profile which comprises intensity values for I₂, I₃, _{I5} and I₇. The processor 104 is arranged to derive the first data profile from these intensity values.

To determine if the multilayer polymer film substrate 1020 is genuine or counterfeit, the processor 104 is arranged to compare the first data profile to the second data profile. If the profiles match, the processor 104 is arranged to output a positive authentication signal indicating that the substrate being tested is genuine.

The processor 104 may be further arranged to determine the thickness of the reference layer and its position within the body of the film substrate. To make such a determination, the processor 104 is arranged to calculate the difference in intensity ΔI between the reference beam 150 and the transmission beam 152 as received by the detector 112. From this difference, the film's thickness can be determined. Thus,

ΔI=I₇−I₅=I₄−I₄e^{-βz3}

The processor 104 is arranged to look-up, from memory 105, the intensity value of I₄ and the absorption coefficient(s) β of the material(s) which is/are expected to be in the multilayer polymer film substrate 1020 to calculate z₃ from the above equation. Thus,

$${z}_{3} = \frac{ln ( 1 - \frac{Δ I}{{I}_{4}} )}{- β}$$

Similarly, the processor 104 is arranged to look-up, from memory 105, the intensity value of I₁ and the absorption coefficient(s) β of the material(s) which is/are expected to be in the layers of the multilayer polymer film substrate 1020 above and below the reference layer to calculate z₁ and z₃. Thus,

$${z}_{2} = \frac{ln ( \frac{{I}_{3}}{{I}_{1}} )}{- β}$$

$${z}_{1} = \frac{ln ( \frac{{I}_{2}}{{I}_{1}} )}{- β}$$

Having calculated z₁, z₂, z₃, the processor 104 can calculate the thickness, t, thus: t=z₃−(Z₁+Z₂).

FIG. 14 schematically illustrates another particular arrangement and mode of operation of the apparatus according to one or more embodiments of the present invention. Features which are common to those illustrated in other figures are denoted using like reference numbers.

In this particular arrangement, the apparatus 100 is arranged to employ a timing measurement technique.

Some timing measurement techniques operate via the principle of emitting a pulse of energy carrying particles and/or waves into a material and measuring the time taken for reflections from one or more interfaces within the material to reach a detector device. With knowledge of the speed of the energy carrying particles and/or waves in the material being tested, and using the measured time taken from emission of a pulse to reception of a reflection, the path length of the beam can be calculated from the equation:

distance=velocity×time

The thickness of one or more layers of a material can then be calculated based upon the times that reflections are received at the detector.

The emitter 110 is arranged to emit a reflection beam 158 into the multilayer polymer film substrate 1020 to be reflected by one or more interfaces between layers of the film substrate. Optionally, the emitter 110 may be arranged to emit a transmission beam 160 of energy carrying particles and/or waves through the multilayer polymer film substrate 1020 for detection by a portion of the detector 112 located beneath the multilayer polymer film substrate 1020.

In use, as reflection beam 158 encounters an interface between two adjacent layers, a reflection is generated. In FIG. 14, a reflection from:
an interface between first layer 1021 and second layer 1022 is denoted by reference 158r1;
an interface between second layer 1022 and third layer 1023 is denoted by reference 158r2;
an interface between third layer 1023 and fourth layer 1024 is denoted by reference 158r3; and
a bottom surface of the multilayer polymer film substrate 1020 is denoted by reference 158r4.

As noted above, the processor 104 can determine layer thickness for each layer from the time difference between receipt of successive reflections.

An example of a sensed effect profile comprising a measured time profile from the detector 112 is illustrated schematically in FIG. 15. The reflection beam 158 is emitted by emitter 110 at time t0. The reflection 158r1 from the interface between first layer 1021 and second layer 1022 is received by the detector at time t1, and the reflection 158r2 from the interface between the second layer 1022 and the third layer 1023 is received by the detector at time t2. Similarly, the reflection 158r3 from the interface between the third layer 1023 and the fourth layer 1024 is received by the detector at time t3, and the reflection 158r4 from the bottom surface of the multilayer polymer film substrate 1020 is received by the detector at time t4.

The processor 104 is arranged to derive the first data profile by noting both the time (t0) of emission of the reflection beam 158 and the times of receipt (i.e. t1, t2, t3, t4) of the reflections 158r1, 158r2, 158r3, 158r4. From these noted times, the processor 104 can determine the time difference Δt (i.e. elapsed time) between emission of the reflection beam 158 and receipt of the reflections 158r1, 158r2, 158r3, 158r4.

To determine if the multilayer polymer film substrate 1020 is genuine or counterfeit, the processor 104 is arranged to compare the first data profile to the second data profile. If the profiles match (e.g. the elapsed time from issue of the irradiating beam to receipt of at least one reflection beam and

receipt of at least one other reflection beam correspond to specified elapsed times of the second data profile), the processor 104 is arranged to output a positive authentication signal indicating that the substrate being tested is genuine.

The processor 104 may be further arranged to determine the thickness of one or more layers of the multilayer polymer film substrate 1020 and its/their position(s), i.e. the depths of its/their surfaces, within the body of the film substrate 1020. For the first layer 1021, this can be achieved by determining an elapsed time Δt₁₀ between a time (t0) of emission of the reflection beam 158 and a time (t1) of receipt of the first reflection 158r1. The processor 104 can look-up the velocity of the energy carrying particles and/or waves in the expected film substrate medium. For example, the velocity of electro-magnetic radiation in polypropylene is 2×10⁸ m/s. Of course, other types of energy carrying particles and/or waves may be used (as an alternative, or in addition, to electro-magnetic radiation), such as for example, phonons in an acoustic arrangement. Since the path length is a reflective one, it is twice the thickness of the layer, and so:

distance (i.e. first layer 1021 thickness z₁)=(2×10⁸×Δt₁₀)/2

Similarly, a thickness z₂ of the second layer 1022 can be calculated by determining an elapsed time Δt₂₁ between the time (t1) of receipt of the first reflection 158r1 and a time (t2) of receipt of the second reflection 158r2. Thus:

second layer 1022 thickness z₂=(2×10⁸×Δt₂₁)/2

A thickness z₃ of the third layer 1023 can be calculated by determining an elapsed time Δt₃₂ between the time (t2) of receipt of the second reflection 158r2 and a time (t3) of receipt of the third reflection 158r3. Thus:

third layer 1023 thickness z₃=(2×10⁸×Δt₃₂)/2

A thickness z₄ of the fourth layer 1024 can be calculated by determining an elapsed time Δt₄₃ between the time (t3) of receipt of the third reflection 158r3 and a time (t4) of receipt of the fourth reflection 158r4. Thus:

fourth layer 1024 thickness z₄=(2×10⁸×Δt₄₃)/2

Finally, an overall thickness z₅ of the multilayer polymer film substrate 1020 can be calculated by determining an elapsed time Δtₘ between the time (t0) of emission of the reflection beam 158 and the time (t4) of receipt of the fourth reflection 158r4. Thus:

film substrate overall thickness z₅=(2×10⁸×Δt₄₀)/2

Optionally, the processor 104 may calculate the overall thickness z₅ of the multilayer polymer film substrate 1020 by determining an elapsed time between a time of emission (tₑ) of transmission beam 160 and the time of receipt (tᵣ) of the transmission beam 160 at the detector 112. Thus:

film substrate overall thickness z₅=2×10⁸×(tᵣ−tₑ)

In an optional arrangement of one or more embodiments of the present invention, the electro-magnetic radiation detector 112 may comprise a spectrometer. The spectrometer may comprise a narrow input slit through which received electro-magnetic radiation diffracts, and an array of charge coupled device (CCD) detector elements arranged to measure the intensity of electro-magnetic radiation at different wavelengths. Other types of detector may be employed, such as back-thinned CCDs, complementary metal oxide semiconductor detector (CMOS), n-type metal oxide semiconductor array (NMOS), or an indium gallium arsenide (InGaAs) photovoltaic detector array.

The fluorescent taggant material in the at least one reference layer of the multilayer polymer film substrate may comprise, for example, a UV fluorescent, a daylight fluorescent, a phosphorescent, an anti-Stokes phosphor, or a material which gives rise to Raman scattering. The materials can either be the film itself or particles that have been added to the film in one or more of the layers of the film, or even one or more special fluorescing layers within the material itself

In one or more of the above-described embodiments, the memory of the apparatus may comprise a data storage element (e.g. ROM) for storing one or more second data profiles and a working memory or cache (e.g. RAM).

In one or more of the above-described embodiments, the second data profile may have been obtained initially by testing a known genuine multilayer polymer film substrate using the apparatus. This second data profile compilation process could, for example, be performed as part of a calibration process of the apparatus 100. The second data profile obtained may then be stored in memory and be referred to during testing of other multilayer polymer film substrates.

In yet further optional arrangements, one or more of the features of the above-described one or more embodiments may be employed in different combinations to form other embodiments of the apparatus.

In an optional arrangement of one or more embodiments comprising the features illustrated in FIG. 8, and as described above with reference to that figure, the apparatus 100 may be configured to detect for a film substrate having a repeating, alternating layer structure. That is, for a film substrate in which the layer structure is A-B-A-B-A-B, etc. Layers A may be undoped (i.e. not containing a taggant) and layers B may comprise a taggant. If the B-layers comprise a fluorescent taggant, then when those layers of the film substrate are excited using the apparatus 100 (e.g. with a visible, ultra-violet, or an infra-red source), some sub-detectors will, due to constructive interference, receive reflections, whereas others will not (due to destructive interference). Alternatively, the A-layers could contain a taggant of a first type and the B-layer could contain a taggant of a second type.

In an optional arrangement of one or more embodiments comprising the features illustrated in FIG. 13, and as described above with reference to that figure, the apparatus 100 may be configured to detect for a film substrate having a reference layer containing only a passive taggant material. In another optional arrangement of one or more embodiments comprising the features illustrated in FIG. 13, and as described above with reference to that figure, the apparatus 100 may be configured to detect for a film substrate having a reference layer containing only an active taggant material. In yet another optional arrangement of one or more embodiments comprising the features illustrated in FIG. 13, and as described above with reference to that figure, the apparatus 100 may be configured to detect for a film substrate having a first reference layer containing a passive taggant material and a second reference layer containing an active taggant material.

In the illustrated one or more embodiments, point electro-magnetic radiation emission sources and point detectors are shown. However, in optional arrangements, linear electro-magnetic radiation emission sources and/or linear detectors may be used. In yet further optional arrangements, a combination of point sources, linear sources, point detector and/or linear detectors may be used.

In other optional arrangements, the first data profile may be derived from data obtained using an ellipsometry technique. Ellipsometry techniques analyse data from a polarised-angled reflection to reveal information regarding the physical composition of transparent and opaque samples. Ellipsometry could be used to find the depth and information regarding the emissions from layers within a polymer film. The first data profile derived from data obtained using such a technique may then be compared to the second data profile by the processor and an authentication signal is provided based upon the comparison. The second data profile may also have been obtained initially by employing an ellipsometry technique to test a known genuine multilayer polymer film substrate. The second data profile obtained may then be stored in memory and be referred to during testing of other multilayer polymer film substrates.

A bifurcated fibre optic bundle 114 illustrated in FIG. 1 provides a means for conveying electro-magnetic radiation to/from a film substrate being tested. Optionally, other means may be provided for conveying the electro-magnetic radiation to/from the film substrate being tested. Also, any suitable shielding equipment may be employed to inhibit the effect of ambient influences on the effect sensing device.

In the description above, any reference to “light” is intended to include electro-magnetic radiation in both the “visible” part of the electro-magnetic spectrum and also the “invisible” part of the electro-magnetic spectrum.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement methods and apparatus is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as, Liberate, OCAP, MHP, Flash, HTML and associated languages, JavaScript, PHP, C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette, or solid-state memory.

Any references made herein to orientation (e.g. top, bottom, upper, lower, front, back, left and right) are made for the purposes of describing relative spatial arrangements of the features of the apparatus, and are not intended to be limiting in any sense.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. An apparatus for indicating if a security document comprises one or more specified characteristics, said apparatus comprising:
an effect sensing device operative to sense at least one of:
a stimulated effect arising due to:
an interaction of a plurality of energy carrying particles and/or waves with a passive taggant material in said at least one reference layer; and
an interaction of a plurality of energy carrying particles and/or waves with an interface between said at least one reference layer and at least one adjacent layer;
and
a spontaneous effect arising due to spontaneous emission of a plurality of energy carrying particles and/or waves from an active taggant material in said at least one reference layer; and
output, to a processor of said apparatus, a sensed effect profile representative of said spontaneous and/or stimulated effect as sensed;
wherein said processor is arranged to:
derive a first data profile from said sensed effect profile;
compare said first data profile with a second data profile representative of a specified effect profile; and
produce an authentication signal representative of a match or otherwise between said first data profile and said second data profile.

2. The apparatus according to claim 1, further comprising an energy carrier source device arranged to direct a plurality of energy carrier particles and/or waves at said substrate to bring about said stimulated effect.

3. The apparatus according to claim 1, wherein said effect sensing device comprises an electro-magnetic radiation detector arranged to sense said spontaneous effect through sensing intensity of electro-magnetic radiation received due to spontaneous emission of electro-magnetic radiation from said active taggant material in said at least one reference layer.

4. The apparatus according to claim 2, wherein said energy carrier source device comprises an electro-magnetic radiation emitter arranged to irradiate said multilayer polymer film with electro-magnetic radiation.

5. The apparatus according to claim 4, wherein said effect sensing device comprises an electro-magnetic radiation detector arranged to:
sense said stimulated effect through sensing at least one of:
intensity of electro-magnetic radiation reflected from interfaces between adjacent layers of said multilayer polymer film and/or as intensity of electro-magnetic radiation transmitted through said multilayer polymer film; and
intensity of electro-magnetic radiation received due to stimulated emission of electro-magnetic radiation from said passive taggant material in said at least one reference layer caused by stimulation by irradiating electro-magnetic radiation from said electro-magnetic emitter; and
output said sensed effect profile as a sensed intensity profile to said processor.

6. The apparatus according to claim 5, wherein said processor is arranged to derive said first data profile by relating said sensed intensity profile to wavelength of said reflected electro-magnetic radiation and masking a portion of said sensed intensity profile over a particular range of wavelengths.

7. The apparatus according to claim 6, wherein said processor is arranged to:
compare said first and second data profiles to determine if a peak corresponding to a particular wavelength, or a particular wavelength range, of reflected electro-magnetic radiation in said first data profile corresponds to a peak corresponding to a specified wavelength, or a specified wavelength range, of said second data profile; and
output a positive authentication signal if said peak in said first data profile matches said peak in said second data profile.

8. The apparatus according to claim 7, wherein said processor is further arranged to:
determine that a first end point of said particular wavelength range in which said peak occurs in said first data profile is representative of an interface between a surface of a non-reference layer and a first surface of said reference layer, and that a second end point of said particular wavelength range in which said peak occurs in said first data profile is representative of an interface between a second surface of said reference layer and a surface of another non-reference layer.

9. The apparatus according to claim 8, wherein said processor is arranged to determine from said first and second end points of said particular wavelength range:
a depth of said interface between said surface of said non-reference layer and said first surface of said reference layer;
a depth of said interface between said second surface of said reference layer and said surface of said other non-reference layer; and
a thickness of said reference layer from a difference between said depth of each interface.

10. The apparatus according to claim 5, wherein said processor is further arranged to derive said first data profile by transforming, using a transformation function algorithm, said sensed intensity profile into a frequency domain profile comprising a data profile of power spectral density versus thickness.

11. The apparatus according to claim 10, wherein said processor is arranged to:
compare said first and second data profiles to determine if a peak or peaks in said frequency domain profile of said first data profile correspond to a peak or peaks in a frequency domain profile of said second data profile; and
output a positive authentication signal if said peak or peaks in said frequency domain profile of said first data profile match peak or peaks in said frequency domain profile of said second data profile.

12. The apparatus according to claim 11, wherein said processor is arranged to:
mask a portion of said frequency domain profile of said first data profile and mask a corresponding portion of said frequency domain profile of said second data profile;
compare unmasked portions of said first and second data profiles to determine if a peak or peaks in an unmasked portion of said frequency domain profile of said first data profile correspond to a peak or peaks in an unmasked portion of said frequency domain profile of said second data profile; and
output a positive authentication signal if said peak or peaks in said unmasked portion of said frequency domain profile of said first data profile match peak or peaks in said unmasked portion of said frequency domain profile of said second data profile.

13. The apparatus according to claim 11, wherein said processor is further arranged to determine that:
a position of said peak or peaks in said frequency domain profile of said first data profile is representative of at least:
a depth of an interface between a surface of a first layer and a first surface of a second layer; and
a depth of an interface between a second surface of said second layer and a surface of a third layer; and
a thickness of said second layer.

14. The apparatus according to claim 13, wherein said processor is arranged to:
mask a portion of said frequency domain profile of said first data profile and mask a corresponding portion of said frequency domain profile of said second data profile;
compare unmasked portions of said first and second data profiles to determine if a peak or peaks in an unmasked portion of said frequency domain profile of said first data profile correspond to a peak or peaks in an unmasked portion of said frequency domain profile of said second data profile; and
output a positive authentication signal if said peak or peaks in said unmasked portion of said frequency domain profile of said first data profile match peak or peaks in said unmasked portion of said frequency domain profile of said second data profile,
wherein said processor is further arranged to determine from said peak or peaks in said unmasked portion of said frequency domain profile of said first data profile:
a depth of said interface between said surface of said first layer and said first surface of said second layer;
a depth of said interface between said second surface of said second layer and said surface of said third layer;
a thickness of said second layer from a difference between said depth of each interface; and
that said second layer comprises said reference layer based upon a comparison of, and match between, said determined depth and thickness values and specified depth and thickness values.

15. The apparatus according to claim 10, wherein said transformation function algorithm comprises a fast Fourier transform.

16. The apparatus according to claim 5, wherein said electro-magnetic radiation detector comprises an array of sub-detectors in which:
at least one sub-detector is configured to detect for said stimulated effect by detecting for electro-magnetic radiation reflected from a first depth within said multilayer polymer film; and
at least one other sub-detector is configured to detect for said stimulated effect by detecting for electro-magnetic radiation reflected from at least one other depth within said multilayer polymer film;
said detector arranged to output said sensed effect profile as an intensity measurement profile to said processor, and wherein said processor is arranged to:
collate intensity measurements output from each of said sub-detectors; and
assign a sub-detector indication reference to each intensity measurement based upon a respective sub-detector which provided said intensity measurement.

17. The apparatus according to claim 16, wherein said processor is arranged to derive said first data profile by:
noting, from said sub-detector indication reference, said at least one sub-detector at which reflected electro-magnetic radiation is received; and
determining, for each beam of reflected electro-magnetic radiation received, a depth of each interface between adjacent layers giving rise to each said beam of reflected electro-magnetic radiation;
said determination based upon:
a spacing between said sub-detector at which a particular beam of reflected electro-magnetic radiation is received and said electro-magnetic radiation emitter; and
a spacing between said sub-detector and a reference point in said detector array.

18. The apparatus according to claim 16, wherein said electro-magnetic radiation emitter is further arranged to irradiate said multilayer polymer film with at least two beams of electro-magnetic radiation emitted at different angles; and further wherein:
at least a first one of said at least one sub-detectors is configured to detect for said stimulated effect by detecting for a first of said at least two beams of electro-magnetic radiation reflected from said first depth within said multilayer polymer film;
at least a second one of said at least one sub-detectors is configured to detect for said stimulated effect by detecting for a second of said at least two beams of electro-magnetic radiation reflected from said first depth within said multilayer polymer film;
at least a third one of said at least one sub-detectors is configured to detect for said stimulated effect by detecting for said first of said at least two beams of electro-magnetic radiation reflected from said at least one other depth within said multilayer polymer film;
at least a fourth one of said at least one sub-detectors is configured to detect for said stimulated effect by detecting for said second of said at least two beams of electro-magnetic radiation reflected from said at least one other depth within said multilayer polymer film;
said detector arranged to output said sensed effect profile as an intensity measurement profile to said processor, and wherein said processor is arranged to:
collate intensity measurements output from each of said sub-detectors; and
assign a sub-detector indication reference to each intensity measurement based upon a respective sub-detector which provided said intensity measurement.

19. The apparatus according to claim 18, wherein said processor is arranged to derive said first data profile by:
noting, from said sub-detector indication reference, at least two sub-detectors at which reflected electro-magnetic radiation is received; and
determining, for each received reflection of an electro-magnetic radiation beam emitted at a first angle and at a different angle, a depth of each interface between adjacent layers giving rise to each received reflection of an electro-magnetic radiation beam emitted at said first angle and at said different angle;
said determination based upon a spacing between:
a first sub-detector at which is received a particular reflection, from a particular interface, of an electro-magnetic radiation beam emitted at a first angle; and
a second sub-detector at which is received a particular reflection, from said same particular interface, of an electro-magnetic radiation beam emitted at a second.

20. The apparatus according to claim 17, wherein said processor is further arranged to:
compare said first data profile comprising interface depth data with said second data profile which comprises data identifying specified interface depths to determine if interface depth data of said first data profile corresponds to data identifying specified interface depths of said second data profile; and
output a positive authentication signal if said interface depth data of said first data profile matches data identifying specified interface depths of said second data profile.

21. The apparatus according to claim 20, wherein said processor is further arranged to:
calculate a thickness of each layer in said multilayer polymer film from said first data profile comprising interface depth data; and
calculate a depth of first and/or second surfaces of each said layer from first and/or second surfaces of said multilayer polymer film.

22. The apparatus according to claim 5, said apparatus further comprising focusing optics controllable to focus an irradiating electro-magnetic radiation beam emitted by said electro-magnetic radiation emitter to a focal point at a particular depth, and further wherein said electro-magnetic radiation detector is arranged to:
sense said stimulated effect through sensing intensity of electro-magnetic radiation emitted from said focal point as a result of stimulation by said irradiating electro-magnetic radiation beam; and
output said sensed effect profile as a sensed intensity profile to said processor.

23. The apparatus according to claim 22, wherein said processor is further arranged to:
control movement of said focussing optics over a movement range to move a focal point position through a plurality of different positions corresponding to said movement range; and
compile said first data profile from a plurality of sensed intensity profiles received from said electro-magnetic radiation detector corresponding to said plurality of different positions of said focal point.

24. The apparatus according to claim 23, wherein said processor is further arranged to:
compare said first data profile with said second data profile which comprises data identifying a specified intensity profile for said plurality of different focal point positions to determine if said first data profile corresponds to said specified intensity profile of said second data profile; and
output a positive authentication signal if said first data profile matches said specified intensity profile of said second data profile.

25. The apparatus according to claim 24, wherein said processor is further arranged to:
determine if an intensity value of said first data profile increases above and/or decreases below a specified threshold intensity value;
determine that any said increase from a position below, to a position above said specified threshold intensity value, or vice versa, due to a change in focal point position, is indicative of said focal point position changing from a position at one side of an interface between two adjacent layers to a position at an opposite side of said interface.

26. The apparatus according to claim 25, wherein said processor is further arranged to:
determine that an increase from a position below, to a position above said specified threshold intensity value is indicative of said focal point position changing from a position in a non-reference layer of said multilayer polymer film to a position in a reference layer containing a stimulable taggant; and
determine that a decrease from a position above, to a position below said specified threshold intensity value is indicative of said focal point position changing from a position in said reference layer containing said stimulable taggant to a position in said non-reference layer of said multilayer polymer film.

27. The apparatus according to claim 26, wherein said processor is further arranged to calculate, from said first data profile:
a thickness of said reference layer in said multilayer polymer film; and
a depth of first and/or second surfaces of said reference layer from first and/or second surfaces of said multilayer polymer film;
by determining focal point positions at which said increase from a position below, to a position above said specified threshold intensity value, or vice versa, occurs.

28. The apparatus according to claim 5, wherein said processor is further arranged to compile said first data profile from at least:
a sensed intensity profile received from said electro-magnetic radiation detector corresponding to electro-magnetic radiation emitted from said at least one reference layer; and
a sensed intensity profile received from said electro-magnetic radiation detector corresponding to transmission of electro-magnetic radiation transmitted through said multilayer polymer film.

29. The apparatus according to claim 28, wherein said processor is further arranged to:
compare said first data profile with said second data profile which comprises data identifying a specified intensity profile for a multilayer polymer film containing a taggant material in a reference layer at a particular depth;
determine if said first data profile corresponds to said specified intensity profile of said second data profile; and
output a positive authentication signal if said first data profile matches said specified intensity profile of said second data profile.

30. The apparatus according to claim 29, wherein said processor is further arranged to calculate a thickness of said reference layer in said multilayer polymer film and a depth of first and/or second surfaces of said reference layer from first and/or second surfaces of said multilayer polymer film from intensity values of said first data profile corresponding to:
electro-magnetic radiation emitted from said first surface of said multilayer polymer film;
electro-magnetic radiation emitted from said second surface of said multilayer polymer film; and
electro-magnetic radiation transmitted through said multilayer polymer film.

31. The apparatus according to claim 30, wherein said processor is arranged to implement said calculation using Beer-Lambert's law.

32. The apparatus according to claim 1, wherein said effect sensing device is arranged to:
sense said stimulated effect through noting a time of reception of a reflection beam of a or said plurality of energy carrying particles and/or waves from interfaces between adjacent layers of said multilayer polymer film; and
output said sensed effect profile as a noted time profile to said processor.

33. The apparatus according to claim 32, further comprising an energy carrier source device arranged to direct a plurality of energy carrier particles and/or waves at said substrate to bring about said stimulated effect,
wherein said processor is further arranged to derive said first data profile by:
noting a time at which an irradiating beam is directed into said multilayer polymer film by said energy carrier source device;
noting, for each received reflection beam, a time of receipt of each said reflection beam;
determining an elapsed time from issue of said irradiating beam to receipt of at least one reflection beam from a difference between said time at which said irradiating beam is directed into said multilayer polymer film by said energy carrier source device and said time of receipt of said at least one reflection beam;
determining an elapsed time from issue of said irradiating beam to receipt of at least one other reflection beam from a difference between said time at which said irradiating beam is directed into said multilayer polymer film by said energy carrier source device and said time of receipt of said at least one other reflection beam.

34. The apparatus according to claim 33, wherein said processor is further arranged to:
compare said first and second data profiles to determine if said elapsed time from issue of said irradiating beam to receipt of said at least one reflection beam and receipt of said at least one other reflection beam correspond to specified elapsed times of said second data profile; and
output a positive authentication signal if said elapsed times in said first data profile match corresponding ones in said second data profile.

35. The apparatus according to claim 34, wherein said processor is further arranged to calculate a thickness of said reference layer in said multilayer polymer film and a depth of first and/or second surfaces of said reference layer from first and/or second surfaces of said multilayer polymer film from elapsed time values of said first data profile corresponding to an elapsed time from issue of said irradiating beam to times of receipt of at least two of:
receipt of a reflection beam from said first surface of said reference layer;
receipt of a reflection beam from said second surface of said reference layer;
receipt of a reflection beam from said first surface of said multilayer polymer film substrate; and
receipt of a reflection beam from said second surface of said multilayer polymer film substrate.

36. The apparatus according to claim 2, wherein said effect sensing device is further arranged to:
sense said stimulated effect through noting a time of receipt of a transmission beam of said plurality of energy carrying particles and/or waves as transmitted through said multilayer polymer film from said energy carrier source device; and
output said sensed effect profile as a noted time profile to said processor.

37. The apparatus according to claim 36,
wherein said processor is further arranged to derive said first data profile by:
noting a time at which an irradiating beam is directed into said multilayer polymer film by said energy carrier source device;
noting, for a received transmission beam, a time of receipt of said transmission beam;
determining an elapsed time from issue of said irradiating beam to receipt of said transmission beam from a difference between said time at which said irradiating beam is directed into said multilayer polymer film by said energy carrier source device and said time of receipt of said transmission beam.

38. The apparatus according to claim 37, wherein said processor is further arranged to:
compare said first and second data profiles to determine if said elapsed time from issue of said irradiating beam to receipt of said transmission beam corresponds to a specified elapsed time of said second data profile; and
output a positive authentication signal if said elapsed time in said first data profile matches a corresponding one in said second data profile.

39. The apparatus according to claim 38, wherein said processor is further arranged to calculate a thickness of said multilayer polymer film substrate from elapsed time values of said first data profile corresponding to an elapsed time from issue of said irradiating beam to receipt of a transmission beam transmitted through said multilayer polymer film substrate.

40. The apparatus according to claim 32, wherein said plurality of energy carrying particles and/or waves comprise photons.

41. The apparatus according to claim 32, further comprising an energy carrier source device arranged to direct a plurality of energy carrier particles and/or waves at said substrate to bring about said stimulated effect,
wherein said plurality of energy carrying particles and/or waves comprise, or further comprise phonons, further wherein said energy carrier source device comprises, or further comprises, an acoustic emission device, and said effect sensing device comprises, or further comprises, an acoustic detector.

42. A method of determining if a security document comprises one or more specified characteristics, said method comprising:
sensing at least one of:
a stimulated effect arising due to:
an interaction of a plurality of energy carrying particles and/or waves with a passive taggant material in said at least one reference layer; and
an interaction of a plurality of energy carrying particles and/or waves with an interface between said at least one reference layer and at least one adjacent layer;
and
a spontaneous effect arising due to spontaneous emission of a plurality of energy carrying particles and/or waves from an active taggant material in said at least one reference layer; and
outputting, from an effect sensing device to a processor, a sensed effect profile representative of said spontaneous and/or stimulated effect as sensed;
deriving, in said processor, a first data profile from said sensed effect profile;
comparing, in said processor, said first data profile with a second data profile representative of a specified effect profile; and
producing, from said processor, an authentication signal representative of a match or otherwise between said first data profile and said second data profile.

43. The method according to claim 42, further comprising directing, from an energy carrier source device, a plurality of energy carrier particles and/or waves at said substrate to bring about said stimulated effect.

44. The method according to claim 42, further comprising sensing said spontaneous effect through sensing intensity of electro-magnetic radiation received due to spontaneous emission of electro-magnetic radiation from said active taggant material in said at least one reference layer.

45. The method according to claim 43, further comprising:
irradiating said multilayer polymer film with electro-magnetic radiation.

46. The method according to claim 45, further comprising:
sensing said stimulated effect through sensing at least one of:
intensity of electro-magnetic radiation reflected from interfaces between adjacent layers of said multilayer polymer film and/or as intensity of electro-magnetic radiation transmitted through said multilayer polymer film; and
intensity of electro-magnetic radiation received due to stimulated emission of electro-magnetic radiation from said passive taggant material in said at least one reference layer; and
outputting said sensed effect profile as a sensed intensity profile to said processor.

47. The method according to claim 46, further comprising deriving, in said processor, said first data profile by relating said sensed intensity profile to wavelength of said reflected electro-magnetic radiation and masking a portion of said sensed intensity profile over a particular range of wavelengths.

48. The method according to claim 47, further comprising:
comparing said first and second data profiles to determine if a peak corresponding to a particular wavelength, or a particular wavelength range, of reflected electro-magnetic radiation in said first data profile corresponds to a peak corresponding to a specified wavelength, or a specified wavelength range, of said second data profile; and
outputting a positive authentication signal if said peak in said first data profile matches said peak in said second data profile.

49. The method according to claim 48, further comprising determining that a first end point of said particular wavelength range in which said peak occurs in said first data profile is representative of an interface between a surface of a non-reference layer and a first surface of said reference layer, and that a second end point of said particular wavelength range in which said peak occurs in said first data profile is representative of an interface between a second surface of said reference layer and a surface of another non-reference layer.

50. The method according to claim 49, further comprising determining from said first and second end points of said particular wavelength range:
a depth of said interface between said surface of said non-reference layer and said first surface of said reference layer;
a depth of said interface between said second surface of said reference layer and said surface of said other non-reference layer; and
a thickness of said reference layer from a difference between said depth of each interface.

51. The method according to claim 46, further comprising deriving said first data profile by transforming, using a transformation function algorithm, said sensed intensity profile into a frequency domain profile comprising a data profile of power spectral density versus thickness.

52. The method according to claim 51, further comprising:
comparing said first and second data profiles to determine if a peak or peaks in said frequency domain profile of said first data profile correspond to a peak or peaks in a frequency domain profile of said second data profile; and
outputting a positive authentication signal if said peak or peaks in said frequency domain profile of said first data profile match peak or peaks in said frequency domain profile of said second data profile.

53. The method according to claim 52, further comprising:
masking a portion of said frequency domain profile of said first data profile and masking a corresponding portion of said frequency domain profile of said second data profile;
comparing unmasked portions of said first and second data profiles to determine if a peak or peaks in an unmasked portion of said frequency domain profile of said first data profile correspond to a peak or peaks in an unmasked portion of said frequency domain profile of said second data profile; and
outputting a positive authentication signal if said peak or peaks in said unmasked portion of said frequency domain profile of said first data profile match peak or peaks in said unmasked portion of said frequency domain profile of said second data profile.

54. The method according to claim 52, further comprising determining that:
a position of said peak or peaks in said frequency domain profile of said first data profile is representative of at least:
a depth of an interface between a surface of a first layer and a first surface of a second layer; and
a depth of an interface between a second surface of said second layer and a surface of a third layer; and
a thickness of said second layer.

55. The method according to claim 54, further comprising:
masking a portion of said frequency domain profile of said first data profile and masking a corresponding portion of said frequency domain profile of said second data profile;
comparing unmasked portions of said first and second data profiles to determine if a peak or peaks in an unmasked portion of said frequency domain profile of said first data profile correspond to a peak or peaks in an unmasked portion of said frequency domain profile of said second data profile;
outputting a positive authentication signal if said peak or peaks in said unmasked portion of said frequency domain profile of said first data profile match peak or peaks in said unmasked portion of said frequency domain profile of said second data profile; and
determining from said peak or peaks in said unmasked portion of said frequency domain profile of said first data profile:
a depth of said interface between said surface of said first layer and said first surface of said second layer;
a depth of said interface between said second surface of said second layer and said surface of said third layer;
a thickness of said second layer from a difference between said depth of each interface; and
that said second layer comprises said reference layer based upon a comparison of, and match between, said determined depth and thickness values and specified depth and thickness values.

56. The method according to claim 51, wherein said transformation function algorithm comprises a fast Fourier transform.

57. The method according to claim 46, further comprising:
detecting, in at least one sub-detector of an array of sub-detectors of an electro-magnetic radiation detector:
said stimulated effect by detecting for electro-magnetic radiation reflected from a first depth within said multilayer polymer film; and
said stimulated effect by detecting for electro-magnetic radiation reflected from at least one other depth within said multilayer polymer film;
outputting said sensed effect profile as an intensity measurement profile to said processor; and
collating intensity measurements output from each of said sub-detectors; and
assigning a sub-detector indication reference to each intensity measurement based upon a respective sub-detector which provided said intensity measurement.

58. The method according to claim 57, further comprising deriving said first data profile by:
noting, from said sub-detector indication reference, said at least one sub-detector at which reflected electro-magnetic radiation is received; and
determining, for each beam of reflected electro-magnetic radiation received, a depth of each interface between adjacent layers giving rise to each said beam of reflected electro-magnetic radiation;
said determination based upon:
a spacing between said sub-detector at which a particular beam of reflected electro-magnetic radiation is received and said electro-magnetic radiation emitter; and
a spacing between said sub-detector and a reference point in said detector array.

59. The method according to claim 57, further comprising:
irradiating said multilayer polymer film with at least two beams of electro-magnetic radiation emitted at different angles;
detecting, in at least a first one of said at least one sub-detectors, said stimulated effect by detecting for a first of said at least two beams of electro-magnetic radiation reflected from said first depth within said multilayer polymer film;
detecting, in at least a second one of said at least one sub-detectors, said stimulated effect by detecting for a second of said at least two beams of electro-magnetic radiation reflected from said first depth within said multilayer polymer film;
detecting, in at least a third one of said at least one sub-detectors, said stimulated effect by detecting for said first of said at least two beams of electro-magnetic radiation reflected from said at least one other depth within said multilayer polymer film;
detecting, in at least a fourth one of said at least one sub-detectors, said stimulated effect by detecting for said second of said at least two beams of electro-magnetic radiation reflected from said at least one other depth within said multilayer polymer film;
outputting said sensed effect profile as an intensity measurement profile to said processor;
collating intensity measurements output from each of said sub-detectors; and
assigning a sub-detector indication reference to each intensity measurement based upon a respective sub-detector which provided said intensity measurement.

60. The method according to claim 59, further comprising deriving said first data profile by:
noting, from said sub-detector indication reference, at least two sub-detectors at which reflected electro-magnetic radiation is received; and
determining, for each received reflection of an electro-magnetic radiation beam emitted at a first angle and at a different angle, a depth of each interface between adjacent layers giving rise to each received reflection of an electro-magnetic radiation beam emitted at said first angle and at said different angle;
said determination based upon a spacing between:
a first sub-detector at which is received a particular reflection, from a particular interface, of an electro-magnetic radiation beam emitted at a first angle; and
a second sub-detector at which is received a particular reflection, from said same particular interface, of an electro-magnetic radiation beam emitted at a second.

61. The method according to claim 58, further comprising:
comparing said first data profile comprising interface depth data with said second data profile which comprises data identifying specified interface depths to determine if interface depth data of said first data profile corresponds to data identifying specified interface depths of said second data profile; and
outputting a positive authentication signal if said interface depth data of said first data profile matches data identifying specified interface depths of said second data profile.

62. The method according to claim 61, further comprising:
calculating a thickness of each layer in said multilayer polymer film from said first data profile comprising interface depth data; and
calculating a depth of first and/or second surfaces of each said layer from first and/or second surfaces of said multilayer polymer film.

63. The method according to claim 46, further comprising:
focusing an irradiating electro-magnetic radiation beam emitted by an electro-magnetic radiation emitter to a focal point at a particular depth;
sensing said stimulated effect through sensing intensity of electro-magnetic radiation emitted from said focal point as a result of stimulation by said irradiating electro-magnetic radiation beam; and
outputting said sensed effect profile as a sensed intensity profile to said processor.

64. The method according to claim 63, further comprising:
controlling movement of said focussing optics over a movement range to move a focal point position through a plurality of different positions corresponding to said movement range; and
compiling said first data profile from a plurality of sensed intensity profiles received from said electro-magnetic radiation detector corresponding to said plurality of different positions of said focal point.

65. The method according to claim 64, further comprising:
comparing said first data profile with said second data profile which comprises data identifying a specified intensity profile for said plurality of different focal point positions to determine if said first data profile corresponds to said specified intensity profile of said second data profile; and
outputting a positive authentication signal if said first data profile matches said specified intensity profile of said second data profile.

66. The method according to claim 65, further comprising:
determining if an intensity value of said first data profile increases above and/or decreases below a specified threshold intensity value;
determining that any said increase from a position below, to a position above said specified threshold intensity value, or vice versa, due to a change in focal point position, is indicative of said focal point position changing from a position at one side of an interface between two adjacent layers to a position at an opposite side of said interface.

67. The method according to claim 66, further comprising:
determining that an increase from a position below, to a position above said specified threshold intensity value is indicative of said focal point position changing from a position in a non-reference layer of said multilayer polymer film to a position in a reference layer containing a stimulable taggant; and
determine that a decrease from a position above, to a position below said specified threshold intensity value is indicative of said focal point position changing from a position in said reference layer containing said stimulable taggant to a position in said non-reference layer of said multilayer polymer film.

68. The method according to claim 67, further comprising calculating, from said first data profile:
a thickness of said reference layer in said multilayer polymer film; and
a depth of first and/or second surfaces of said reference layer from first and/or second surfaces of said multilayer polymer film;
by determining focal point positions at which said increase from a position below, to a position above said specified threshold intensity value, or vice versa, occurs.

69. The method according to claim 46, further comprising compiling said first data profile from at least:
a sensed intensity profile received from an electro-magnetic radiation detector corresponding to electro-magnetic radiation emitted from said at least one reference layer; and
a sensed intensity profile received from an electro-magnetic radiation detector corresponding to transmission of electro-magnetic radiation transmitted through said multilayer polymer film.

70. The method according to claim 69, further comprising:
comparing said first data profile with said second data profile which comprises data identifying a specified intensity profile for a multilayer polymer film containing a taggant material in a reference layer at a particular depth;
determining if said first data profile corresponds to said specified intensity profile of said second data profile; and
outputting a positive authentication signal if said first data profile matches said specified intensity profile of said second data profile.

71. The method according to claim 70, further comprising calculating a thickness of said reference layer in said multilayer polymer film and a depth of first and/or second surfaces of said reference layer from first and/or second surfaces of said multilayer polymer film from intensity values of said first data profile corresponding to:
electro-magnetic radiation emitted from said first surface of said multilayer polymer film;
electro-magnetic radiation emitted from said second surface of said multilayer polymer film; and
electro-magnetic radiation transmitted through said multilayer polymer film.

72. The method according to claim 71, further comprising implementing said calculation using Beer-Lambert's law.

73. The method according to claim 42, further comprising:
sensing said stimulated effect through noting a time of reception of a reflection beam of a or said plurality of energy carrying particles and/or waves from interfaces between adjacent layers of said multilayer polymer film; and
outputting said sensed effect profile as a noted time profile to said processor.

74. The method according to claim 73, further comprising deriving said first data profile by:
noting a time at which an irradiating beam is directed into said multilayer polymer film by an energy carrier source device;
noting, for each received reflection beam, a time of receipt of each said reflection beam;
determining an elapsed time from issue of said irradiating beam to receipt of at least one reflection beam from a difference between said time at which said irradiating beam is directed into said multilayer polymer film and said time of receipt of said at least one reflection beam;
determining an elapsed time from issue of said irradiating beam to receipt of at least one other reflection beam from a difference between said time at which said irradiating beam is directed into said multilayer polymer film and said time of receipt of said at least one other reflection beam.

75. The method according to claim 74, further comprising:
comparing said first and second data profiles to determine if said elapsed time from issue of said irradiating beam to receipt of said at least one reflection beam and receipt of said at least one other reflection beam correspond to specified elapsed times of said second data profile; and
outputting a positive authentication signal if said elapsed times in said first data profile match corresponding ones in said second data profile.

76. The method according to claim 75, further comprising calculating a thickness of said reference layer in said multilayer polymer film and a depth of first and/or second surfaces of said reference layer from first and/or second surfaces of said multilayer polymer film from elapsed time values of said first data profile corresponding to an elapsed time from issue of said irradiating beam to times of receipt of at least two of:
a reflection beam from said first surface of said reference layer;
a reflection beam from said second surface of said reference layer;
a reflection beam from said first surface of said multilayer polymer film substrate; and
a reflection beam from said second surface of said multilayer polymer film substrate.

77. The method according to claim 73, further comprising:
sensing said stimulated effect through noting a time of receipt of a transmission beam of said plurality of energy carrying particles and/or waves as transmitted through said multilayer polymer film from an energy carrier source device; and
outputting said sensed effect profile as a noted time profile to said processor.

78. The method according to claim 77, further comprising deriving said first data profile by:
noting a time at which an irradiating beam is directed into said multilayer polymer film;
noting, for a received transmission beam, a time of receipt of said transmission beam;
determining an elapsed time from issue of said irradiating beam to receipt of said transmission beam from a difference between said time at which said irradiating beam is directed into said multilayer polymer and said time of receipt of said transmission beam.

79. The method according to claim 78, further comprising:
comparing said first and second data profiles to determine if said elapsed time from issue of said irradiating beam to receipt of said transmission beam corresponds to a specified elapsed time of said second data profile; and
outputting a positive authentication signal if said elapsed time in said first data profile matches a corresponding one in said second data profile.

80. The method according to claim 79, further comprising calculating a thickness of said multilayer polymer film substrate from elapsed time values of said first data profile corresponding to an elapsed time from issue of said irradiating beam to receipt of a transmission beam transmitted through said multilayer polymer film substrate.

81. The method according to claim 73, wherein said plurality of energy carrying particles and/or waves comprises photons.

82. (canceled)

83. A banknote counting apparatus comprising the apparatus according to claim 1, said banknote counting apparatus further comprising a note counting device arranged to maintain a count of banknotes conveyed through said apparatus.

84. The banknote counting apparatus according to claim 83, wherein said note counting device is further arranged to maintain a count of genuine banknotes conveyed through said apparatus and as identified as genuine banknotes by the apparatus.

85. The banknote counting apparatus according to claim 83, further arranged to convey genuine banknotes as identified by the apparatus to a first banknote storage position.

86. A computer program comprising computer program elements operative in a computer processor to implement one or more aspects of the method according to claim 42.

87. A computer readable medium carrying the computer program according to claim 86.

88. A multilayer polymer film substrate, comprising at least one reference layer for influencing a spontaneous and/or stimulated effect detectable by the apparatus according to claim 1.

89. The multilayer polymer film substrate according to claim 88, wherein the at least one reference layer comprises a taggant material for influencing said spontaneous and/or stimulated effect detectable by the apparatus.

90-92. (canceled)
